(19) United States
(12) Patent Application Publication
(10) Pub. No.: US 2010/0153749 A1
(43) Pub. Date: Jun. 17, 2010

(54) DEVICE-ACCESS CONTROL PROGRAM, DEVICE-ACCESS CONTROL PROCESS, AND INFORMATION PROCESSING APPARATUS FOR CONTROLLING ACCESS TO DEVICE

(75) Inventor: Atsushi Sakai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/715,121

(22) Filed: Mar. 1, 2010

Related U.S. Application Data
(63) Continuation of application No. PCT/JP2007/069357, filed on Oct. 3, 2007.

(51) Int. Cl. G06F 12/14; H04L 9/00; G06F 13/28

(52) U.S. Cl. 713/193; 380/277; 710/22; 711/E12.092

(57) ABSTRACT

In a computer on which operating systems (OSs) run in parallel: a key storage with a memory area different from that used by the Oss stores keys for use by the OSs in encryption-related processing of data which is to be inputted into or outputted from a device, in correspondence with the OSs; and an encryption processor encrypts first data outputted from a first OS by using a first key corresponding to the first OS in response to a first request by the first OS for access to the device before transferring the first data to the device, and decrypts second data being encrypted and outputted from the device, by using a second key corresponding to a second OS in response to a second request by the second OS for access to the device before transferring the second data to the second OS.

This application is a continuing application, filed under 35 U.S.C. Section 111(a), of International Application PCT/JP2007/069357, filed Oct. 3, 2007.

### FIELD

The embodiments discussed herein relate to a computer-readable medium storing a device-access control program for controlling access to a device from an operating system, and a device-access control process and an information processing apparatus for controlling access to a device.

### BACKGROUND

The computer virtualization techniques, which virtually realize the functions of a plurality of computers on a single physical computer, are known. On the physical computer, an individual operating system runs in correspondence with each of virtual computers. The plurality of operating systems running on the physical computer commonly use hardware resources (such as a CPU, a RAM, and the like) which the physical computer has. Application programs (hereinafter referred to as applications) executed on one of the operating systems can perform processing without caring about the other operating systems. Since the plurality of operating systems run in parallel as above, the provision of the plurality of operating systems is externally perceived as if a plurality of computers exist.

In some cases, the above applications executed on the operating systems may use an HDD (Hard Disk Drive), an NIC (Network Interface Card), and the like. However, in a computer in which a plurality of operating systems run, the plurality of operating systems can compete for access to a device. Therefore, in such a computer, an access control program for arbitrating access to the device is executed. When one of the operating systems issues a request (access request) for access to the device, the access control program acquires the access request, resolves conflicts concerning the access, and transfers the access request to the device. That is, the access control program relays, in a centralized manner, requests for access to the device which are received from the plurality of operating systems.

Incidentally, in order to ensure the confidentiality of data handled by the computer, the data are commonly encrypted before the data are outputted to a device. The contents of the encrypted data cannot be referred to without a decryption key. Therefore, the encryption of data before storage of the data in a storage device can reduce the risk of data leakage in the case where the storage device is stolen.

According to a known technique for encryption as above, a key is stored in advance in an area of the storage device, and encryption processing is performed by reading the key into an operating system when necessary. (See, for example, Japanese Laid-open Patent Publication No. 2001-154919.) According to another known technique for encryption, a policy for data access is preset in a computer in which a plurality of operating systems run, and each operating system performs encryption on the basis of the policy. (See, for example, Japanese Laid-open Patent Publications Nos. 2002-318719 and 2003-345654.) In the case where data are automatically encrypted in accordance with a judgement made by the operating system, instead of the application, as in the above techniques, data outputted to the device can be protected with high reliability.

However, according to the techniques disclosed in Japanese Laid-open Patent Publications Nos. 2001-154919, 2002-318719, and 2003-345654, the key is read into the operating system at least when the encryption processing is performed. Therefore, if the kernel of the operating system is attacked by an unauthorized program such as a computer virus, the key can be improperly acquired and externally leaked. The risk of leakage of the key caused by the attack on the operating system conspicuously increases in computers in each of which a plurality of operating systems run in parallel.

### SUMMARY

According to an aspect of the present invention, there is provided a computer-readable medium storing a device-access control program which makes a computer perform processing for controlling access to one or more devices, where the computer has memory areas and a plurality of operating systems run in parallel in the computer. The stored device-access control program realizes in the computer: a key storage which includes memory areas different from memory areas used by the plurality of operating systems, to store one or more keys for use by one or more of the plurality of operating systems in encryption-related processing of data which is to be inputted into the one or more devices or is outputted from the one or more devices, in correspondence with the one or more of the plurality of operating systems; and an encryption processor which encrypts first data outputted from a first one of the plurality of operating systems by using a first one of the one or more keys corresponding to the first one of the plurality of operating systems in response to a first request by the first one of the plurality of operating systems for access to the one or more devices before transferring the first data to the one or more devices, and decrypts second data being encrypted and outputted from the one or more devices, by using a second one of the one or more keys corresponding to a second one of the plurality of operating systems in response to a second request by the second one of the plurality of operating systems for access to the one or more devices before transferring the second data to the second one of the plurality of operating systems.

The objects and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWING(S)

FIG. 1 illustrates representative functions of computers according to the embodiments;

FIG. 2 illustrates the hardware of a computer according to the first embodiment;

FIG. 3 is a block diagram illustrating the functions of the computer according to the first embodiment;

FIG. 4 illustrates an example of a key table;

FIG. 5 is a flow diagram illustrating processing for starting the computer;

FIG. 6 is a flow diagram illustrating processing for starting a guest operating system (OS);

FIG. 7 is a flow diagram illustrating processing for adding an encryption key to a guest OS;

FIG. 8 is a flow diagram illustrating processing for writing by a guest OS according to the first embodiment;

FIG. 9 is a schematic diagram illustrating operations for writing by a guest OS according to the first embodiment;

FIG. 10 is a flow diagram illustrating processing for reading by a guest OS according to the first embodiment;

FIG. 11 is a schematic diagram illustrating operations for reading by a guest OS according to the first embodiment;

FIG. 12 is a block diagram illustrating the functions of a computer according to the second embodiment;

FIG. 13 is a flow diagram illustrating processing for writing by a guest OS according to the second embodiment;

FIG. 14 is a schematic diagram illustrating operations for writing by a guest OS according to the second embodiment;

FIG. 15 is a flow diagram illustrating processing for reading by a guest OS according to the second embodiment;

FIG. 16 is a schematic diagram illustrating operations for reading by a guest OS according to the second embodiment;

FIG. 17 is a block diagram illustrating the functions of a computer according to the third embodiment;

FIG. 18 is a block diagram illustrating the functions of a computer according to the fourth embodiment;

FIG. 19 illustrates the hardware of a computer according to the fifth embodiment;

FIG. 20 is a block diagram illustrating the functions of the computer according to the fifth embodiment;

FIG. 21 is a flow diagram illustrating processing for writing by a guest OS according to the fifth embodiment;

FIG. 22 is a schematic diagram illustrating operations for writing by a guest OS according to the fifth embodiment;

FIG. 23 is a flow diagram illustrating processing for reading by a guest OS according to the fifth embodiment; and

FIG. 24 is a schematic diagram illustrating operations for reading by a guest OS according to the fifth embodiment.

### DESCRIPTION OF EMBODIMENT(S)

The embodiments will be explained below with reference to the accompanying drawings, wherein like reference numbers refer to like elements throughout.

### 1. Representative Functions of Embodiments

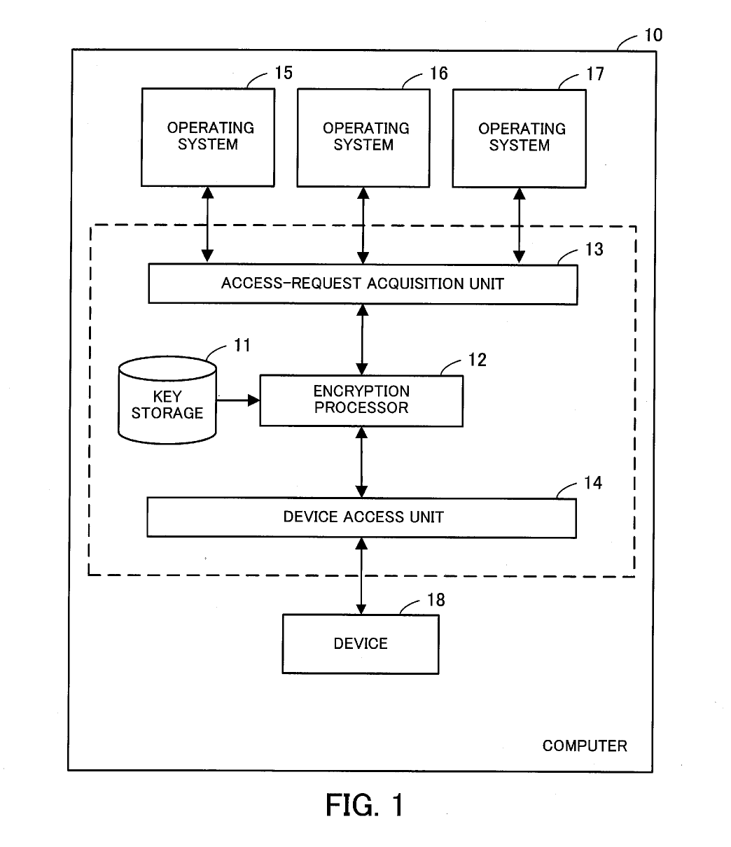

FIG. 1 illustrates representative functions of computers as information processing apparatuses according to the embodiments. The computer 10 illustrated in FIG. 1 comprises a key storage 11, an encryption processor 12, an access-request acquisition unit 13, and a device access unit 14. The operating systems 15, 16, and 17 run in parallel in the computer 10. (Hereinafter, the operating systems are referred to as OSs.) In addition, the computer 10 has a device 18, which is, for example, an HDD (Hard Disk Drive), an NIC (Network Interface Card), and the like.

The key storage 11 stores keys for encryption-related processing of data which is to be inputted into the device 18 or is outputted from the device 18 by the operating systems 15, 16, and 17, in correspondence with the operating systems 15, 16, and 17, respectively. At this time, the key storage has memory areas different from those used by the operating systems 15, 16, and 17 to store the keys. For example, the keys may be stored in memory areas used by a process which runs with a higher execution privilege than the operating systems 15, 16, and 17. Alternatively, the keys may be stored in memory areas used by an OS for management (not shown), which is different from the operating systems 15, 16, and 17.

When the encryption processor 12 receives from one of the operating systems 15, 16, and 17 a request for access to the device 18, the encryption processor 12 encrypts data outputted from the one of the operating systems 15, 16, and 17 before transferring the data to the device 18, and decrypts encrypted data acquired from the device 18 before transferring the data to the one of the operating systems 15, 16, and 17, by using a key corresponding to the one of the operating systems 15, 16, and 17 and being stored in the key storage 11.

The access-request acquisition unit 13 acquires a request for access which is issued by one of the operating systems 15, 16, and 17. In addition, the access-request acquisition unit 13 controls transfer of unencrypted data between the encryption processor 12 and the operating systems 15, 16, and 17. The device access unit 14 controls transfer of encrypted data between the encryption processor 12 and the device 18.

In the above configuration, the operating systems 15, 16, and 17 can directly access neither of the key storage 11 and the encryption processor 12. Therefore, even when one of the operating systems 15, 16, and 17 is attacked by an unauthorized program such as a computer virus, neither of the key storage 11 and the encryption processor 12 is improperly accessed. Thus, leakage of keys for protection of data outputted to the device 18 can be prevented by performing management of keys and encryption-related processing on the path for access from the operating systems 15, 16, and 17 to the device 18, instead of performing management of the keys for encryption by the operating systems 15, 16, and 17.

### 2. First Embodiment

The first embodiment is explained below with reference to the corresponding drawings.

### 2.1 Hardware

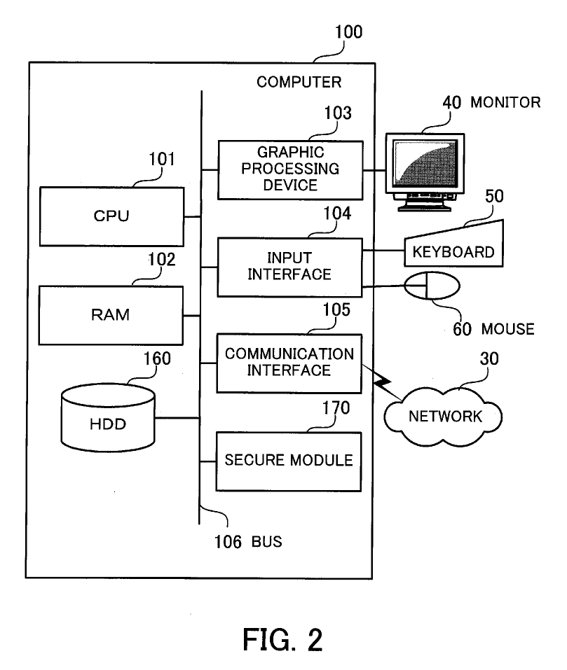

FIG. 2 illustrates the hardware of the computer according to the first embodiment. The entire computer 100 is controlled by a CPU (central processing unit) 101, to which a RAM (random access memory) 102, a graphic processing unit 103, an input interface 104, a communication interface 105, an HDD (hard disk drive) 160, and a secure module 170 are connected through a bus 106. The RAM 102 temporarily stores at least portions of OS (operating system) programs and application programs which are executed by the CPU 101, as well as various types of data necessary for processing performed by the CPU 101. A monitor 40 is connected to the graphic processing unit 103, which makes the monitor 40 display an image on a screen in accordance with an instruction from the CPU 101. A keyboard 50 and a mouse 60 are connected to the input interface 104, which transmits signals sent from the keyboard 50 and the mouse 60, to the CPU 101 through the bus 106. The communication interface 105 is connected to the network 30, and exchanges data with other computers through the network 30. The HDD 160 is a disk device, and stores the OS programs, the application programs, and various data necessary for processing performed by the CPU 101. The secure module 170 is a tamper-resistant module, which executes encryption-related processing and hash calculation of data independently of the CPU 101. The secure module 170 has the functions of generating and holding an encryption key and a decryption key for use in the encryption-related processing. For example, the TPM (Trusted Platform Module) may be used as the secure module 170.

### 2.2 Functions

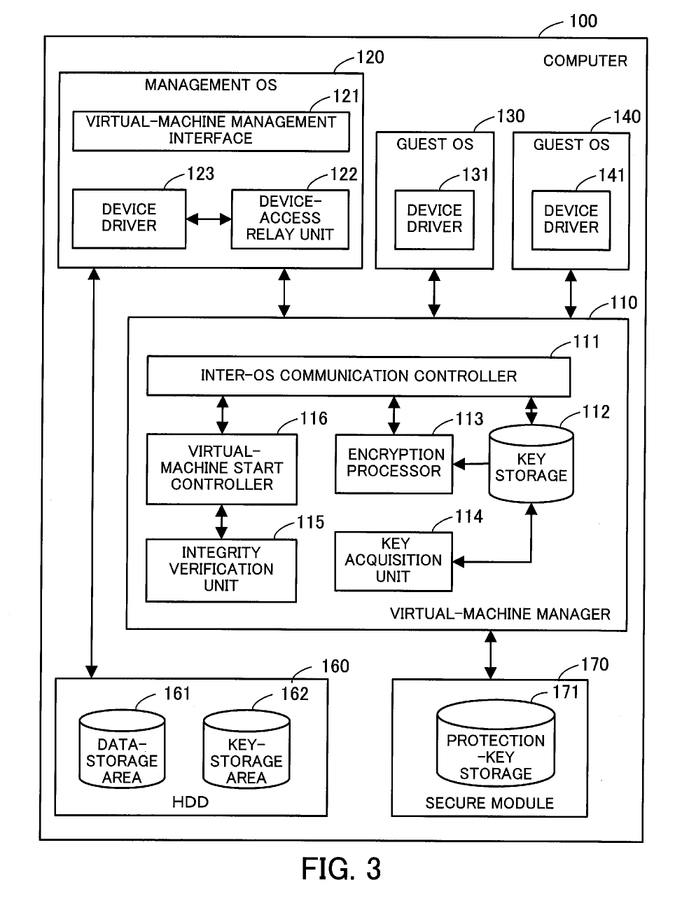

FIG. 3 is a block diagram illustrating the functions of the computer according to the first embodiment. The computer 100 comprises a virtual-machine manager 110, a management OS 120, and guest OSs 130 and 140. The management OS 120 and the guest OSs 130 and 140 are OSs which run in parallel on the computer 100. The virtual-machine manager 110 operates with a higher execution privilege than the guest OSs 130 and 140.

The virtual-machine manager 110 comprises an inter-OS communication controller 111, a key storage 112, an encryption processor 113, a key acquisition unit 114, an integrity verification unit 115, and a virtual-machine start controller 116. The virtual-machine manager 110 provides an execution environment for each of the management OS 120 and the guest OSs 130 and 140. (Such an execution environment is hereinafter referred to as a virtual machine.) When an OS is started on the computer 100, a virtual machine as the execution environment of the OS is started by the virtual-machine manager 110, and the OS runs on the virtual machine.

The inter-OS communication controller 111 controls data transfer between the management OS 120 and the guest OSs 130 and 140. The inter-OS communication controller 111 transfers data to be transferred between OSs, to the encryption processor 113, for performing encryption-related processing of the data when necessary. The key storage 112 stores key information corresponding to each of the guest OSs 130 and 140 and being used in encryption-related processing of data. The key information contains a key and information corresponding to the key and identifying a guest OS. The key information also contains a hash value for use in verification of the integrity of a kernel image or a disk image of each guest OS. In the following explanations, a table containing the above key information is referred to as a key table. Details of the key table are explained later.

The encryption processor 113 performs encryption-related processing of data transferred from the inter-OS communication controller 111, by using the key stored in the key storage 112. The encryption-related processing is encryption or decryption. The encryption processor 113 transfers to the inter-OS communication controller 111 the data after the encryption-related processing is performed.

The key acquisition unit 114 has the function of performing encryption-related processing of a key table and transferring an encrypted key table between the key storage 112 and the HDD 160. Specifically, when the computer 100 is started, the key acquisition unit 114 reads out an encrypted key table from the HDD 160, decrypts the encrypted key table by using a protection key stored in the secure module 170, and stores the decrypted key table in the key storage 112. Further, when the computer 100 is stopped, the key acquisition unit 114 reads out the key table stored in the key storage 112, encrypts the key table by using the protection key stored in the secure module 170, and writes the encrypted key table in the HDD 160.

When a virtual machine is newly started, the integrity verification unit 115 verifies the integrity of the data of at least one of the kernel image and the disk image of one of the guest OSs 130 and 140 which runs on the virtual machine. Then, the integrity verification unit 115 sends the result of the verification to the virtual-machine start controller 116. The verification may be performed on only the kernel image, only the disk image, or both of the kernel image and the disk image. The integrity verification unit 115 is preset in advance by the administrator so as to perform the verification of only the kernel image, only the disk image, or both of the kernel image and the disk image. The virtual-machine start controller 116 receives the result of the verification performed by the integrity verification unit 115. Unless the image data is determined to be tampered with, the virtual-machine start controller 116 continues processing for starting the guest OS which is to be started. When the image data is determined to be tampered with, the virtual-machine start controller 116 stops the processing for starting the guest OS.

The integrity is verified, for example, in the following manner. When a request to start a virtual machine occurs, the integrity verification unit 115 acquires, from the key table stored in the key storage 112, a hash value of at least one of the kernel image and the disk image of the guest OS which runs on the virtual machine. The hash value stored in the key storage 112 is obtained when the preceding (last) run of the guest OS is completed. In addition, the integrity verification unit 115 generates a hash value for verification on the basis of the kernel image or the disk image of the guest OS which is to be started, where the kernel image or the disk image is stored in the HDD 160. Then, the integrity verification unit 115 compares the hash value acquired from the key storage 112 with the hash value generated from the kernel image or the disk image of the guest OS stored in the HDD 160, verifies whether or not the compared hash values are identical, and sends the result of the verification to the virtual-machine start controller 116. When the image is determined not to be tampered with, the virtual-machine start controller 116 starts the target virtual machine and the target guest OS. When the image is determined to be tampered with, the virtual-machine start controller 116 stops the start of the target virtual machine and the target guest OS.

The management OS 120 is an OS for management, and is automatically started after the virtual-machine manager 110 is started. The management OS 120 comprises a virtual-machine management interface 121, a device-access relay unit 122, and a device driver 123. The administrator manages the start and other operations of the other virtual machines and the guest OSs by using the virtual-machine management interface 121 in the management OS 120. The device-access relay unit 122 is an interface for data transfer between the inter-OS communication controller 111 and the device driver 123. The device driver 123 controls access to a device which the computer 100 has. In the example of FIG. 3, the device driver 123 controls access to the HDD 160. Therefore, access to the HDD 160 from each of the key acquisition unit 114, the integrity verification unit 115, and the guest OSs 130 and 140 is relayed by the device driver 123.

Each of the guest OSs 130 and 140 runs on a virtual machine which is realized on the computer 100. Each of the guest OSs 130 and 140 is an OS for a user, and is started in response to a command from the management OS 120. The guest OS 130 has a device driver 131, and the guest OS 140 has a device driver 141. Each of the device drivers 131 and 141 outputs a request for access to a device such as the HDD 160. The range of devices which each of the guest OSs 130 and 140 can access is defined by the virtual-machine manager 110.

The HDD 160 has a data-storage area 161 and a key-storage area 162. Data handled by the guest OSs 130 and 140 are stored in the data-storage area 161, and the key table encrypted with the protection key stored in the secure module 170 is stored in the key-storage area 162.

The secure module 170 comprises a protection-key storage 171. The protection key used by the key acquisition unit 114 for encryption-related processing of the key table is stored in the protection-key storage 171. Therefore, it is difficult for other computers to correctly read the key table stored in the HDD 160. In addition, in contrast to the case where the key table is stored in the secure module 170, shortage of the storage capacity of the secure module 170 will not occur according to the first embodiment even when the size of the key table is increased by increase in the number of the guest OSs.

Alternatively, the computer 100 may be configured so that the encryption-related processing is performed by the guest OSs 130 and 140, instead of the virtual-machine manager 110. In other words, it is possible to set key for use in encryption-related processing by the guest OSs 130 and 140, in addition to the key for use in encryption-related processing by the virtual-machine manager 110. In this case, the above keys are managed by the device drivers 131 and 141.

### 2.3 Key Table

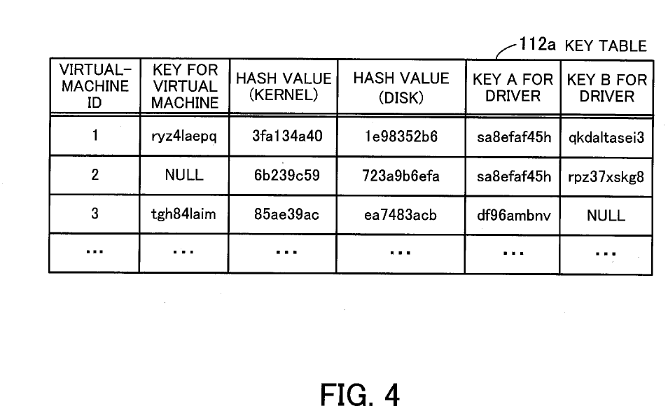

FIG. 4 illustrates an example of the key table. The key table 112a illustrated in FIG. 4 is stored in the key storage 112. The key table 112a has the columns of “Virtual-machine ID,” “Key for Virtual Machine,” “Hash Value A (Kernel),” “Hash Value B (Disk),” “Key A for Driver,” and “Key B for Driver.” The information items tabulated in each row of the key table 112a are associated with each other, and constitute the key information for a virtual machine.

A virtual-machine ID, which is an identifier (ID) for identifying each virtual machine, is set in the column “Virtual-machine ID.” A key for encryption-related processing, which is to be passed to a guest OS which runs on each virtual machine, is set in the column “Key for Virtual Machine.” This key is for use in encryption-related processing performed for each guest OS. When the above key is unnecessary, “NULL” is set in the column “Key for Virtual Machine.”

A hash value of a kernel image which is obtained when the preceding run of each guest OS is completed is set in the column “Hash Value A (Kernel),” and a hash value of a disk image which is obtained when the preceding run of the guest OS is completed is set in the column “Hash Value B (Disk).” The hash values set in the columns “Hash Value A (Kernel)” and “Hash Value B (Disk)” are used in verification of the integrity of the image data, where the verification is performed by the integrity verification unit 115 when the guest OS is started next.

A key for use in encryption-related processing which is performed by the encryption processor 113 when a first device (e.g., the HDD 160) is accessed is set in the column “Key A for Driver,” and a key for use in encryption-related processing which performed by the encryption processor 113 when a second device (e.g., the communication interface 105) is accessed is set in the column “Key B for Driver.” For each device for which encryption is not to be performed, “NULL” is set in the columns “Key A for Driver” and “Key B for Driver.”

In the example of FIG. 4, it is assumed that the common key cryptosystem is used. Since the common key cryptosystem can realize high processing speed, the common key cryptosystem is widely used in the cases where massive data is encrypted. Alternatively, the public key cryptosystem may be used. In the latter case, public keys and secret keys respectively corresponding to the public keys are stored in the key table.

Further, from the viewpoint of flexibility of key management, it is desirable to set a key or keys for encryption-related processing for each device as indicated in the example of FIG. 4. Alternatively, it is possible to set a key common to all the devices.

When a request for access to data occurs on the guest OS 130 or 140, or when the management OS 120 requests to start the guest OS 130 or 140, the key table 112a is referred to during the operation of the computer 100, as needed.

### 2.4 Operations

Hereinbelow, details of the operations performed in the computer 100 configured as above are explained.

### 2.4.1 Processing for Starting Computer

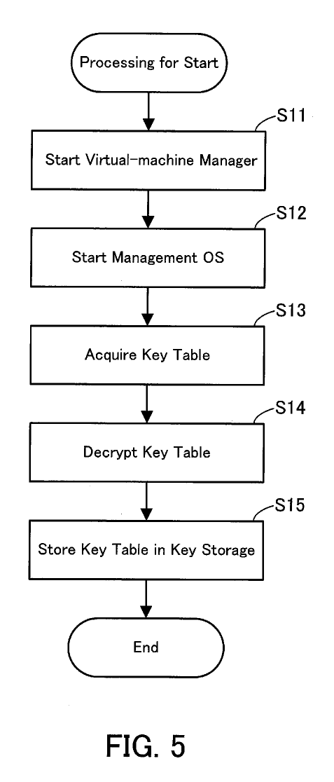

FIG. 5 is a flow diagram illustrating processing for starting the computer 100. The processing of FIG. 5 is explained below step by step.

<Step S11> When the computer 100 is powered on by manipulation of the administrator, first, the computer 100 starts the virtual-machine manager 110.

<Step S12> The virtual-machine start controller 116 starts the virtual machine for the management OS 120, and then starts the management OS 120 on the started virtual machine.

<Step S13> The key acquisition unit 114 acquires the (encrypted) key table 112a from the key-storage area 162 in the HDD 160 through the management OS 120.

<Step S14> The key acquisition unit 114 acquires the protection key from the protection-key storage 171 in the secure module 170, and then decrypts the encrypted key table 112a by using the acquired protection key.

<Step S15> The key acquisition unit 114 stores in the key storage 112 the key table 112a decrypted in step S14.

As described above, when the computer 100 is started, the encrypted key table 112a is decrypted by the key acquisition unit 114, and the decrypted key table 112a is stored in the key storage 112. Since the key table 112a is encrypted by using the protection key managed by the secure module 170 (which is tamper-resistant), it is possible to safely manage the key table 112a.

### 2.4.2 Processing for Starting Guest OS

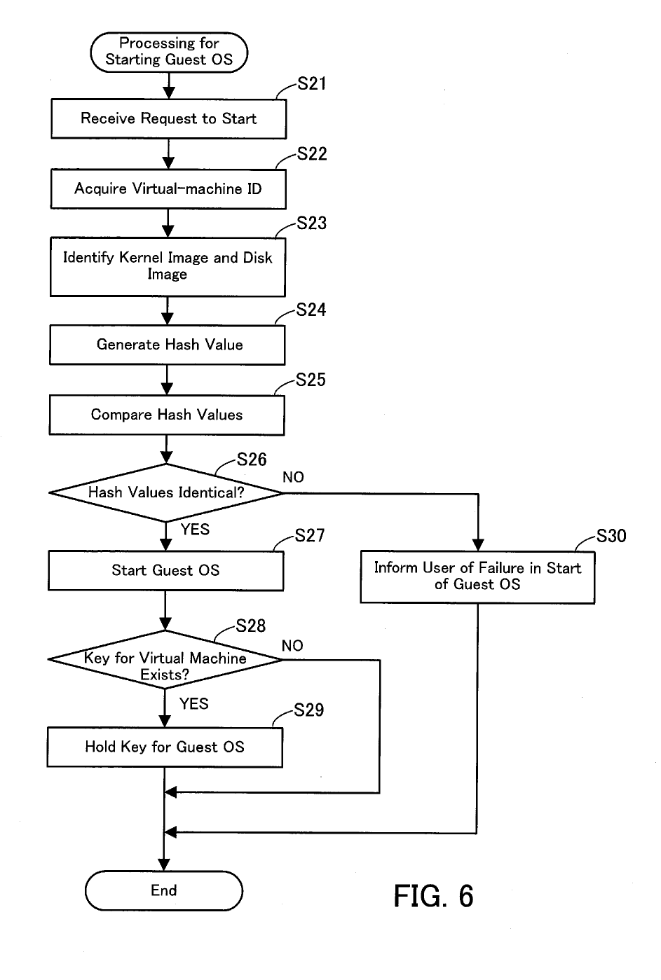

FIG. 6 is a flow diagram illustrating processing for starting a guest OS. The processing of FIG. 6 is explained below step by step. In the following explanations, it is assumed that the guest OS 130 is started. However, processing similar to FIG. 6 is performed for starting the guest OS 140.

<Step S21> The inter-OS communication controller 111 receives from the virtual-machine management interface 121a request to start the guest OS 130.

<Step S22> The inter-OS communication controller 111 reads out the key table 112a from the key storage 112, and then acquires from the key table 112a the virtual-machine ID of the virtual machine on which the guest OS 130 is to run.

<Step S23> The inter-OS communication controller 111 sends to the virtual-machine management interface 121 the virtual-machine ID acquired in step S22. The virtual-machine management interface 121 identifies the location (e.g., the block address in the HDD 160) at which the kernel image and the disk image corresponding to the received virtual-machine ID are stored, on the basis of file management information for the HDD 160, where the file management information is held by the management OS 120. Then, the virtual-machine management interface 121 sends to the inter-OS communication controller 111 information on the identified location, and the inter-OS communication controller 111 transfers to the virtual-machine start controller 116 the received information on the location.

<Step S24> The virtual-machine start controller 116 receives the information on the location, and acquires the kernel image and the disk image of the guest OS 130 from the data-storage area 161 through the management OS 120, on the basis of the received information on the location. Then, the virtual-machine start controller 116 transfers the acquired kernel image and disk image to the integrity verification unit 115. The integrity verification unit 115 generates the hash value(s) of at least one of the kernel image and disk image of the guest OS 130.

<Step S25> The integrity verification unit 115 acquires the hash value(s) of at least one of the kernel image and the disk image which is set in the key table 112a. Then, the integrity verification unit 115 compares the hash value(s) generated in step S24, with the hash value(s) acquired from the key table 112a.

<Step S26> The integrity verification unit 115 determines whether or not the compared hash values are identical. When yes is determined, i.e., when the verification succeeds, the operation goes to step S27. When no is determined, i.e., when the verification fails, the operation goes to step S30.

<Step S27> The integrity verification unit 115 informs the virtual-machine start controller 116 of the success in the verification. Then, the virtual-machine start controller 116 starts the virtual machine on which the guest OS 130 is to run, and starts the guest OS 130 on the basis of the kernel image and the disk image.

<Step S28> The virtual-machine start controller 116 determines whether or not a key for the virtual machine is set in the key table 112a. When yes is determined, the operation goes to step S29. When no is determined, the processing of FIG. 6 for starting the guest OS 130 is completed.

<Step S29> The virtual-machine start controller 116 performs, via the inter-OS communication controller 111, operations for making the guest OS 130 hold the key for the virtual machine (which is stored in the key table 112a). Thereafter, the virtual-machine start controller 116 informs the virtual-machine management interface 121 of the completion of the start of the guest OS 130.

<Step S30> The integrity verification unit 115 informs the virtual-machine start controller 116 of the failure in the verification. Then, the virtual-machine start controller 116 stops the operation for starting the guest OS 130. Thereafter, the virtual-machine start controller 116 informs the virtual-machine management interface 121 of the failure in the start of the guest OS 130.

Since the integrity verification is performed by the integrity verification unit 115 before the start of the guest OS 130 as described above, it is possible to confirm whether or not the kernel image or the disk image of the guest OS 130 is tampered with.

### 2.4.3 Processing for Starting Guest OS

Consider a case where a usable device is added to a guest OS, for example, a case where a new HDD is connected to the computer 100. In such a case, it is necessary to newly set, in the key table 112a, a key for encryption-related processing performed for access from the target guest OS to the newly usable device.

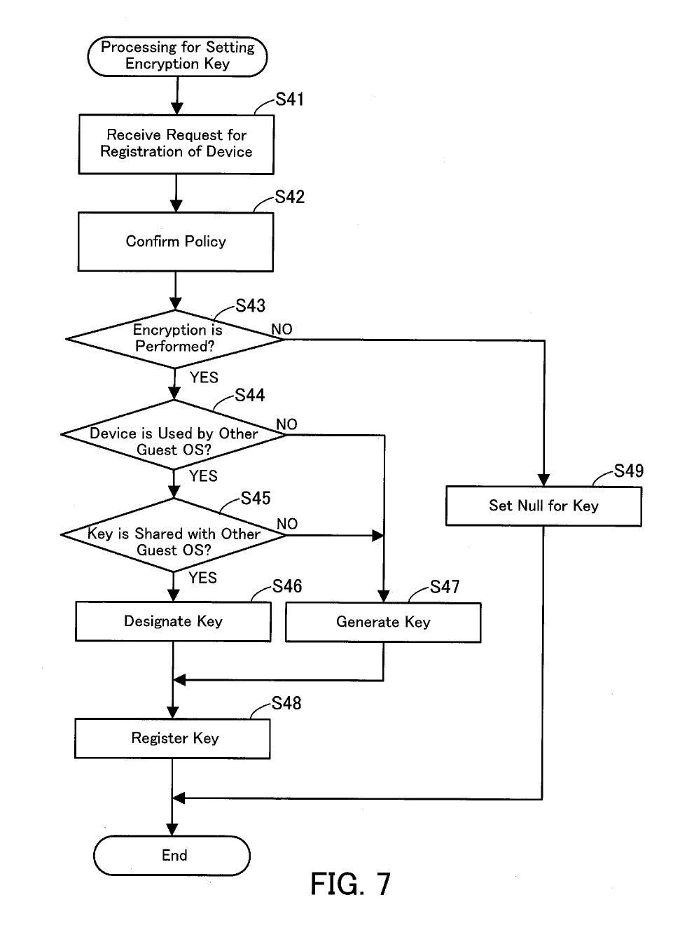

FIG. 7 is a flow diagram illustrating processing for adding an encryption key to a guest OS. The processing of FIG. 7 is explained below step by step. In the following explanations, it is assumed that processing for making a device (hereinafter referred to as the device X) usable to the guest OS 130 is performed. However, processing similar to FIG. 7 is performed for making a device usable to the guest OS 140.

<Step S41> The virtual-machine management interface 121 receives a request to the guest OS 130 for registration of the device X, where the request is issued by the administrator.

<Step S42> The virtual-machine management interface 121 acquires policy information which is set for the device X. The policy information includes information indicating whether or not encryption-related processing is necessary for access to the device and information indicating whether or not the key used for the encryption-related processing is shared by more than one guest OS. The policy information is managed by the virtual-machine management interface 121.

<Step S43> The virtual-machine management interface 121 determines whether or not encryption-related processing is performed in response to a request by the guest OS 130 for access to the device X. This determination is made on the basis of the policy information and/or an explicit instruction from the administrator. When yes is determined, the operation goes to step S44. When no is determined, the operation goes to step S49.

<Step S44> The virtual-machine management interface 121 determines whether or not the device X is already used by another guest OS (which is the guest OS 140 in this example). This determination is made, for example, by reference to the key table 112a. When yes is determined, the operation goes to step S45. When no is determined, the operation goes to step S47.

<Step S45> The virtual-machine management interface 121 determines whether or not the key for the device X can be shared with the other guest OS. This determination is made on the basis of the policy information and/or an explicit instruction from the administrator. When yes is determined, the operation goes to step S46. When no is determined, the operation goes to step S47.

<Step S46> The virtual-machine management interface 121 designates a key which is already generated for the other guest OS, as the key for use in access from the guest OS 130 to the device X. Then, the virtual-machine management interface 121 informs the inter-OS communication controller 111 of the designation of the key.

<Step S47> The virtual-machine management interface 121 newly generates a key for the device X, and then transmits the generated key to the inter-OS communication controller 111.

<Step S48> The inter-OS communication controller 111 sets, in the key table 112a stored in the key storage 112, the key designated in step S46 or the key received in step S47, as a key for a driver which is arranged for access from the guest OS 130 to the device X.

<Step S49> The virtual-machine management interface 121 informs the inter-OS communication controller 111 that no key is set for the driver which is arranged for access from the guest OS 130 to the device X. Then, the inter-OS communication controller 111 sets “NULL” for the driver which is arranged for access from the guest OS 130 to the device X.

As described above, the virtual-machine management interface 121 can newly define a device for the guest OS 130 at an arbitrary time. In addition, when the virtual-machine management interface 121 newly define a device, the virtual-machine management interface 121 determines whether or not encryption-related processing is performed for access to the device, by reference to the policy information or a designation by the administrator. Further, the virtual-machine management interface 121 generates a key only for each of the devices for which encryption-related processing is performed. Although the management OS 120 generates the key in the above processing, alternatively, it is possible to configure the computer 100 so that the virtual-machine manager 110 generates the key.

### 2.4.4 Processing for Writing and Reading by Guest OS

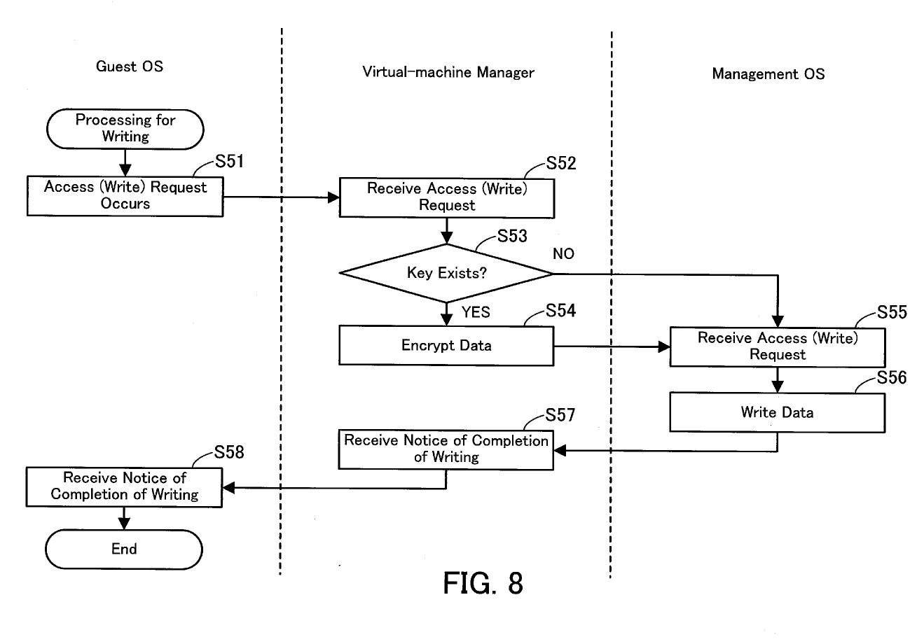

FIG. 8 is a flow diagram illustrating processing for writing by a guest OS according to the first embodiment. The processing of FIG. 8 is explained below step by step. In the following explanations, it is assumed that the processing for writing is performed by the guest OS 130. However, processing similar to FIG. 8 is performed when writing is performed by the guest OS 140.

<Step S51> The device driver 131 receives a request (write request) for writing data in the HDD 160, where the write request is issued by an application executed on the guest OS 130. Then, the device driver 131 transmits the write request to the inter-OS communication controller 111, where the write request is accompanied by data to be written.

<Step S52> The inter-OS communication controller 111 receives the write request from the device driver 131.

<Step S53> The inter-OS communication controller 111 determines whether or not a key for access from the guest OS 130 to the HDD 160 is set in the key table 112a (stored in the key storage 112). When yes is determined, the operation goes to step S54. When no is determined, the inter-OS communication controller 111 transfers the write request to the device-access relay unit 122, and the operation goes to step S55.

<Step S54> The inter-OS communication controller 111 makes the encryption processor 113 encrypt the data to be written, by using the key which is set in the key table 112a. Then, the inter-OS communication controller 111 transmits to the device-access relay unit 122 the write request, which is accompanied by the encrypted data to be written.

<Step S55> The device-access relay unit 122 receives from the inter-OS communication controller 111 the write request, which is accompanied by the encrypted or unencrypted data to be written. Then, the device-access relay unit 122 transfers the write request to the device driver 123.

<Step S56> The device driver 123 performs the operation of writing the data in the data-storage area 161 on the basis of the write request. When the operation of writing the data is completed, the device driver 123 transmits to the device-access relay unit 122 a notice of completion of the writing operation. Then, the device-access relay unit 122 transfers the notice to the inter-OS communication controller 111.

<Step S57> The inter-OS communication controller 111 receives the notice of completion of the writing operation from the device-access relay unit 122, and then transmits the notice to the device driver 131.

<Step S58> The device driver 131 receives the notice of completion of the writing operation from the inter-OS communication controller 111, and thereafter issues a notice of completion of the writing operation to the application which is the source of the write request.

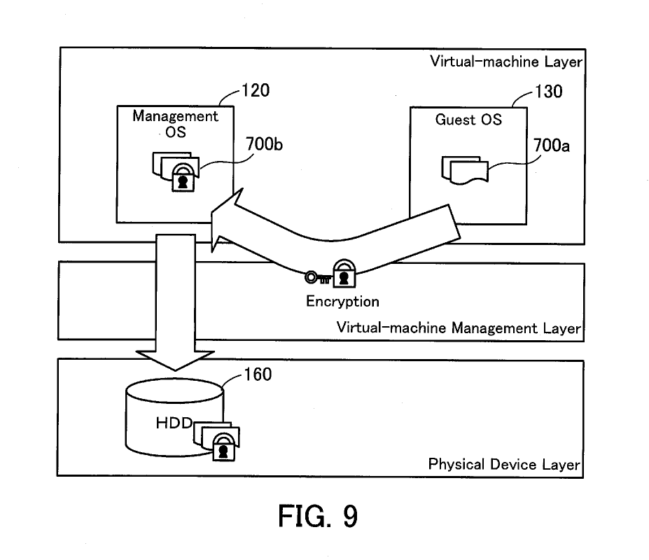

FIG. 9 is a schematic diagram illustrating operations for writing performed by a guest OS according to the first embodiment. In FIG. 9, the functions of the computer 100 are indicated in three layers, the physical device layer, the virtual-machine management layer, and the virtual machine layer. The devices which the computer 100 has belong to the physical device layer. For example, the HDD 160 (which provides physical storage areas), the communication interface 105, and the like are elements belonging to the physical device layer. The processes which manage the virtual machines running on the computer 100 belong to the virtual-machine management layer. For example, the virtual-machine manager 110 is the element belonging to the virtual-machine management layer. The processes of the management OS 120 and the guest OS 130 belong to the virtual machine layer. The virtual machine layer is at a level higher than the virtual-machine management layer. Further, in FIG. 9, reference numeral 700a denotes unencrypted data, and 700b denotes encrypted data. The unencrypted data 700a is used by an application executed on the guest OS 130, and the encrypted data 700b is generated by encrypting the unencrypted data 700a as needed before data storage in the HDD 160. The operations for writing according to the first embodiment are explained below with reference to FIG. 9.

When a write request by the application executed on the guest OS 130 occurs, the write request, accompanied by the unencrypted data 700a, is transferred to the management OS 120 through the virtual-machine management layer. At this time, the unencrypted data 700a is encrypted to generate the encrypted data 700b on the data transfer path in the virtual-machine management layer. Then, the management OS 120 acquires the encrypted data 700b from the virtual-machine management layer, and stores the encrypted data 700b in the HDD 160 on the basis of the received write request.

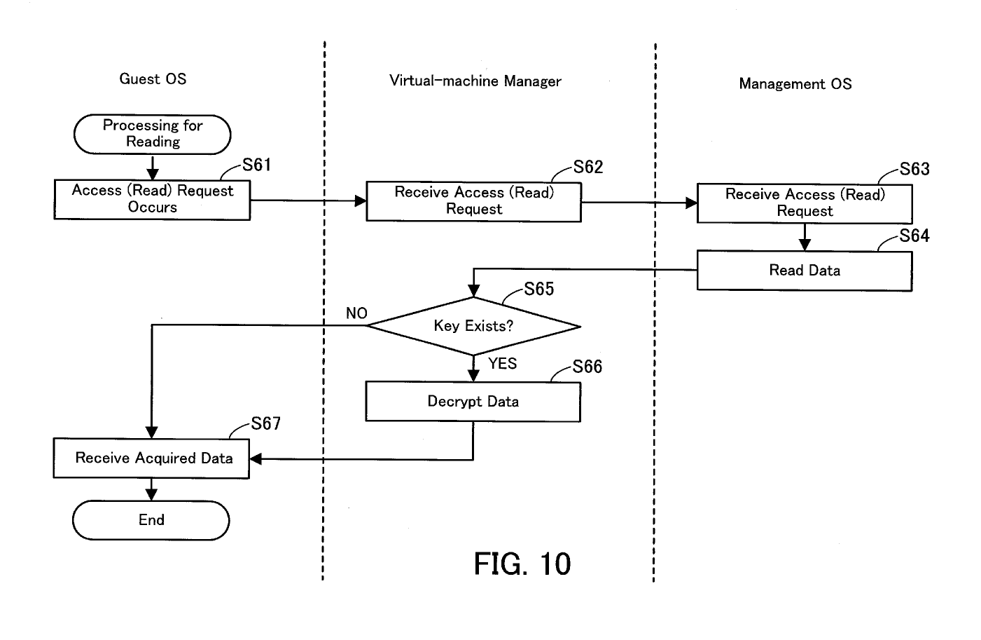

FIG. 10 is a flow diagram illustrating processing for reading by a guest OS according to the first embodiment. The processing of FIG. 10 is explained below step by step. In the following explanations, it is assumed that the processing for reading is performed by the guest OS 130. However, processing similar to FIG. 10 is performed when reading is performed by the guest OS 140.

<Step S61> The device driver 131 receives a request (read request) for reading data, which is issued by an application executed on the guest OS 130. Then, the device driver 131 transmits the read request to the inter-OS communication controller 111.

<Step S62> The inter-OS communication controller 111 receives the read request from the device driver 131, and then transfers the received read request to the device-access relay unit 122.

<Step S63> The device-access relay unit 122 receives the read request from the inter-OS communication controller 111, and then transfers the read request to the device driver 123.

<Step S64> The device driver 123 receives the read request transferred from the device-access relay unit 122, executes processing for reading data from the data-storage area 161 on the basis of the received read request, and transmits the acquired data to the device-access relay unit 122. The device-access relay unit 122 transfers to the inter-OS communication controller 111 the data received from the device driver 123.

<Step S65> The inter-OS communication controller 111 receives data from the device-access relay unit 122, and determines whether or not a key for access from the guest OS 130 to the HDD 160 is set in the key table 112a (stored in the key storage 112). When yes is determined, the operation goes to step S66. When no is determined, the operation goes to step S67.

<Step S66> The inter-OS communication controller 111 makes the encryption processor 113 decrypt the acquired data by using the key which is set in the key table 112a. Then, inter-OS communication controller 111 transfers the decrypted data to the device driver 131.

<Step S67> The device driver 131 receives the decrypted data from the inter-OS communication controller 111, and transfers the data to the application which is the source of the read request.

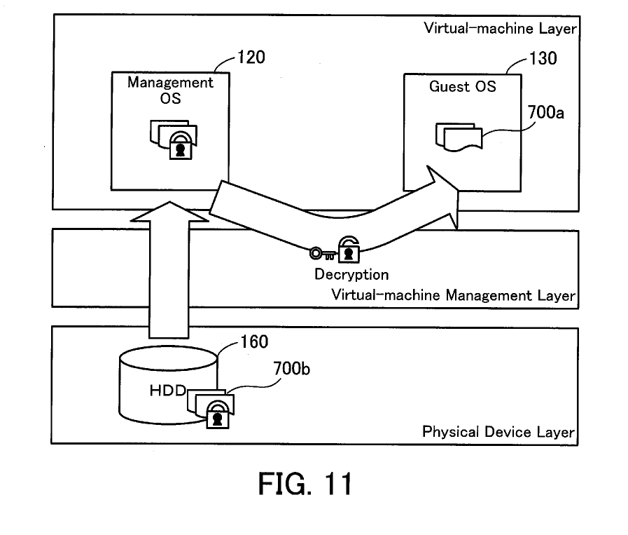

FIG. 11 is a schematic diagram illustrating operations for reading performed by a guest OS according to the first embodiment. The operations for reading according to the first embodiment are explained below with reference to FIG. 11. (However, explanations on operations similar to some operations in FIG. 9 are not repeated.)

When a read request from an application executed on the guest OS 130 occurs, the read request is transferred through the virtual-machine management layer to the management OS 120. Then, the management OS 120 acquires the encrypted data 700b from the HDD 160 on the basis of the received read request, and transfers the acquired encrypted data 700b to the virtual-machine management layer. At this time, the encrypted data 700b is decrypted to generate the unencrypted data 700a on the data transfer path in the virtual-machine management layer. The guest OS 130 acquires the unencrypted data 700a from the virtual-machine management layer.

As described above, when a request for access to data occurs on the guest OS 130, access to the HDD 160 through the virtual-machine management layer and the management OS 120 is performed. In addition, the key table 112a is managed in the virtual-machine management layer, so that the encryption-related processing of data is performed on the data transfer path between the guest OS 130 and the management OS 120. Therefore, the guest OS 130 cannot recognize the functions of the encryption-related processing and the existence of the key. Thus, the key is in no danger of being accessed or leaked out even when the OS is attacked by an unauthorized program such as a computer virus, so that it is possible to improve secrecy of the data stored in the HDD 160.

### 3. Second Embodiment

The second embodiment is explained below with reference to the corresponding drawings. The following explanations on the second embodiment are focused on the differences from the first embodiment, and explanations similar to the first embodiment are not repeated unless necessary.

### 3.1 Functions

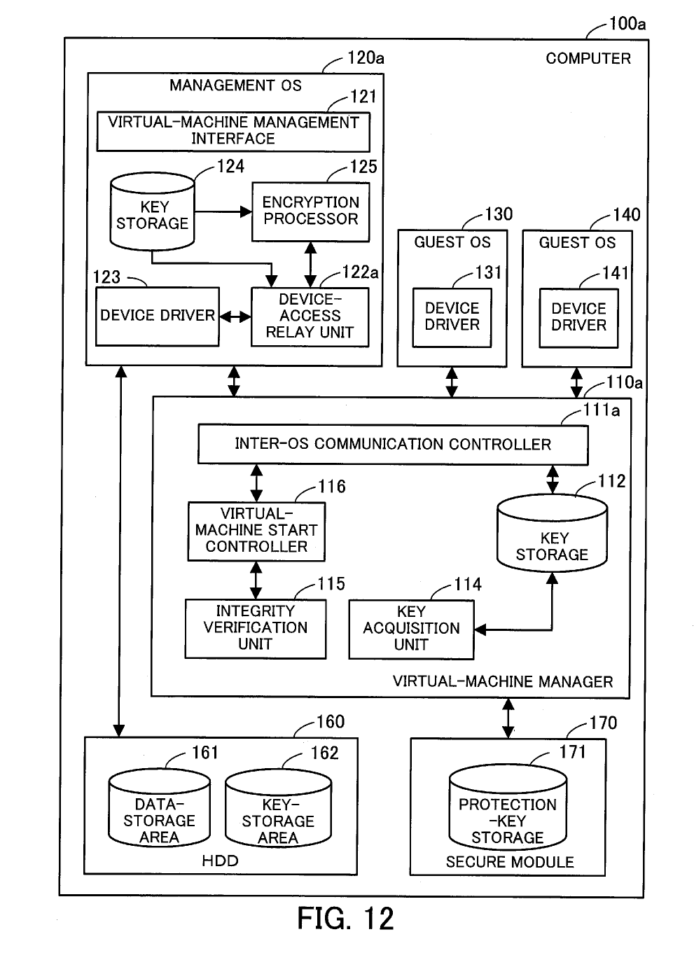

FIG. 12 is a block diagram illustrating the functions of the computer according to the second embodiment. The computer 100a comprises a virtual-machine manager 110a, a management OS 120a, and guest OSs 130 and 140 as well as the HDD 160 and the secure module 170. The management OS 120a and the guest OSs 130 and 140 are OSs which respectively run on virtual machines. The virtual-machine manager 110a operates with a higher execution privilege than the guest OSs 130 and 140.

The virtual-machine manager 110a comprises an inter-OS communication controller 111a, a key storage 112, a key acquisition unit 114, an integrity verification unit 115, and a virtual-machine start controller 116. The virtual-machine manager 110a provides an execution environment for each of the management OS 120a and the guest OSs 130 and 140. When an OS is started on the computer 100a, a virtual machine as the execution environment of the OS is started by the virtual-machine manager 110a, and the OS runs on the virtual machine. The key storage 112, the key acquisition unit 114, the integrity verification unit 115, and the virtual-machine start controller 116 in the computer 100a according to the second embodiment illustrated in FIG. 12 respectively have identical functions and constructions to the corresponding elements in the computer 100 according to the first embodiment illustrated in FIG. 3. The inter-OS communication controller 111a controls data transfer between the management OS 120a and the guest OSs 130 and 140. When the guest OS 130 or 140 is started, the inter-OS communication controller 111a reads out key information corresponding to the guest OS from the key storage 112, and stores the key information in a key storage 124 in the management OS 120a.

The management OS 120a is an OS for management, and is automatically started after the virtual-machine manager 110a is started. The management OS 120a comprises a virtual-machine management interface 121, a device-access relay unit 122a, a device driver 123, the key storage 124, and an encryption processor 125. The administrator manages the start and other operations of the other virtual machines and the guest OSs by using the virtual-machine management interface 121 in the management OS 120a. The virtual-machine management interface 121 and the device driver 123 in the computer 100a according to the second embodiment illustrated in FIG. 12 respectively have identical functions and constructions to the corresponding elements in the computer 100 according to the first embodiment illustrated in FIG. 3. The device-access relay unit 122a is an interface for data transfer between the virtual-machine manager 110a and the device driver 123. At this time, the device-access relay unit 122a transfers data to be transferred between OSs, to the encryption processor 125, as needed, and makes the encryption processor 125 perform encryption-related processing of the data. The key storage 124 stores the key information which corresponds to each guest OS currently running and is used in encryption-related processing of data. Every time a guest OS is started, the inter-OS communication controller 111a reads out the key information corresponding to each guest OS from the key storage 112, and stores the key information in the key storage 124. At this time, the key information includes the information items in the columns “Virtual-machine ID,” “Key A for Driver,” and “Key B for Driver” contained in the key table 112a, which is indicated in FIG. 4. The encryption processor 125 performs encryption-related processing (i.e., encryption or decryption) of data transferred from the device-access relay unit 122a, by using the key stored in the key storage 124, and transfers to the device-access relay unit 122a the data after the encryption-related processing is performed.

The guest OSs 130 and 140, the HDD 160, and the secure module 170 in the computer 100a according to the second embodiment illustrated in FIG. 12 respectively have identical functions and constructions to the corresponding elements in the computer 100 according to the first embodiment illustrated in FIG. 3.

### 3.2 Operations

Hereinbelow, details of the operations performed in the computer 100a configured as above are explained.

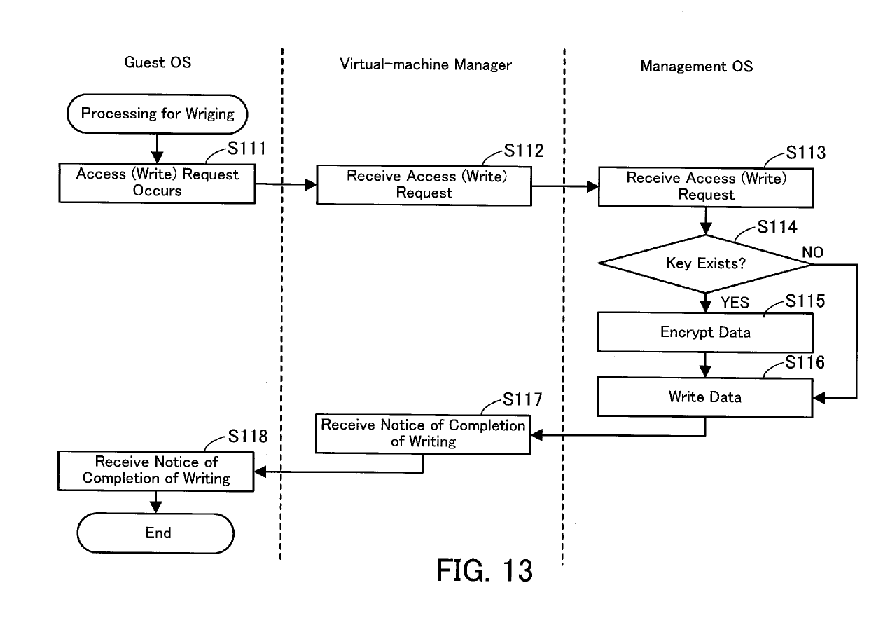

FIG. 13 is a flow diagram illustrating processing for writing by a guest OS according to the second embodiment. The processing of FIG. 13 is explained below step by step. In the following explanations, it is assumed that the processing for writing is performed by the guest OS 130. However, processing similar to FIG. 13 is performed when writing is performed by the guest OS 140.

<Step S111> The device driver 131 receives a request (write request) for writing data in the HDD 160, which is issued by an application executed on the guest OS 130. Then, the device driver 131 transmits the write request to the inter-OS communication controller 111a, where the write request is accompanied by data to be written.

<Step S112> The inter-OS communication controller 111a receives the write request from the device driver 131, and then transfers the received write request to the device-access relay unit 122a.

<Step S113> The device-access relay unit 122a receives the write request from the inter-OS communication controller 111a.

<Step S114> The device-access relay unit 122a refers to the key storage 124, and determines whether or not a key for access from the guest OS 130 to the HDD 160 is set in the key storage 124. When yes is determined, the operation goes to step S115. When no is determined, the device-access relay unit 122a transfers the write request to the device driver 123, and the operation goes to step S116.

<Step S115> The device-access relay unit 122a makes the encryption processor 125 encrypt the data to be written, by using the key which is set in the key storage 124. Then, the device-access relay unit 122a transmits to the device driver 123 the write request accompanied by the encrypted data to be written.

<Step S116> The device driver 123 receives from the device-access relay unit 122a the write request accompanied by the encrypted or unencrypted data to be written. Then, the device driver 123 performs the operation of writing the data in the data-storage area 161 on the basis of the write request. When the operation of writing the data is completed, the device driver 123 transmits to the device-access relay unit 122a a notice of completion of the writing operation. Then, the device-access relay unit 122a transfers the notice to the inter-OS communication controller 111a.

<Step S117> The inter-OS communication controller 111a receives the notice of completion of the writing operation from the device-access relay unit 122a, and then transmits the notice to the device driver 131.

<Step S118> The device driver 131 receives the notice of completion of the writing operation from the inter-OS communication controller 111a, and thereafter issues a notice of completion of the writing operation to the application which is the source of the write request.

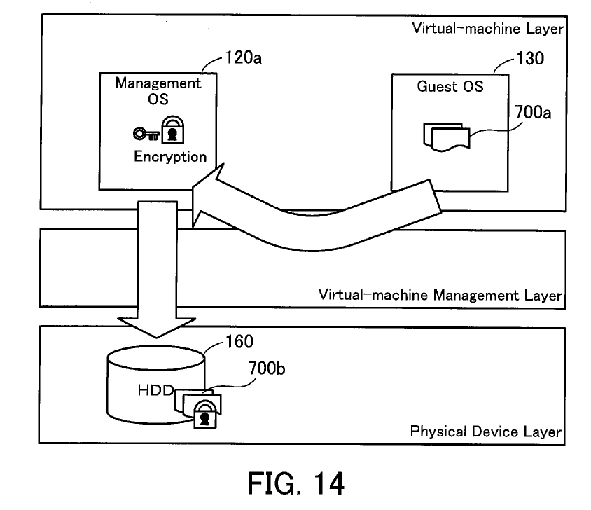

FIG. 14 is a schematic diagram illustrating operations for writing data performed by a guest OS according to the second embodiment. The operations for writing according to the second embodiment are explained below with reference to FIG. 14. (However, explanations on operations similar to some operations in FIG. 9 are not repeated.)

When a write request by the application executed on the guest OS 130 occurs, the write request, which is accompanied by the unencrypted data 700a, is transferred to the management OS 120a through the virtual-machine management layer. Then, the management OS 120a encrypts the unencrypted data 700a to generate the encrypted data 700b, and stores the encrypted data 700b in the HDD 160 on the basis of the received write request.

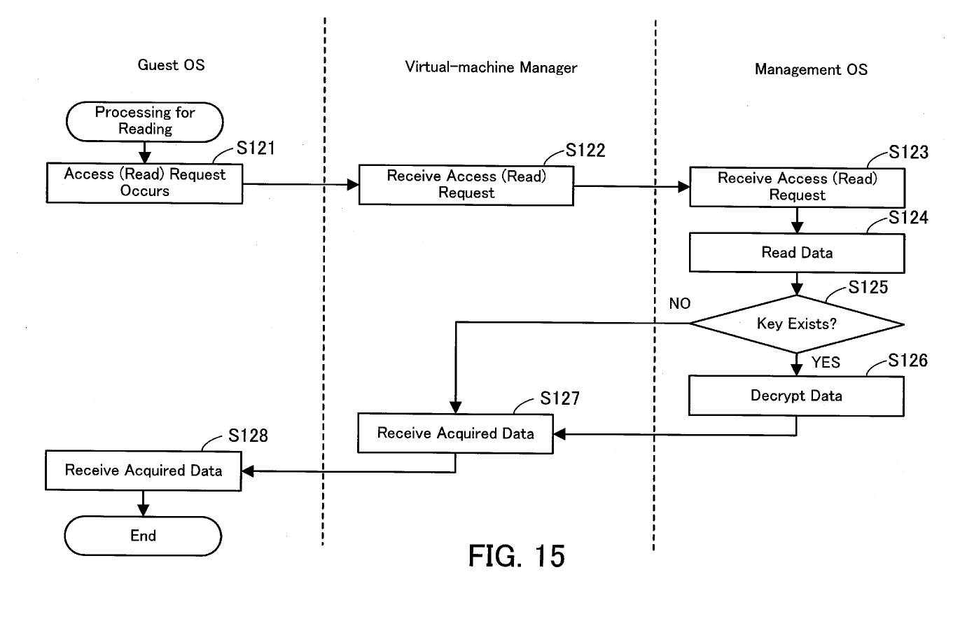

FIG. 15 is a flow diagram illustrating processing for reading by a guest OS according to the second embodiment. The processing of FIG. 15 is explained below step by step. In the following explanations, it is assumed that the processing for reading is performed by the guest OS 130. However, processing similar to FIG. 15 is performed when reading is performed by the guest OS 140.

<Step S121> The device driver 131 receives a request (read request) for reading data, which is issued by an application executed on the guest OS 130. Then, the device driver 131 transmits the read request to the inter-OS communication controller 111a.

<Step S122> The inter-OS communication controller 111a receives the read request from the device driver 131. The inter-OS communication controller 111a transfers the received read request to the device-access relay unit 122a.

<Step S123> The device-access relay unit 122a receives the read request from the inter-OS communication controller 111a, and then transfers the read request to the device driver 123.

<Step S124> The device driver 123 receives the read request transferred from the device-access relay unit 122a. Then, the device driver 123 executes processing for reading data from the data-storage area 161 on the basis of the received read request, and thereafter transmits the acquired data to the device-access relay unit 122a, so that the device-access relay unit 122a receives the acquired data from the device driver 123.

<Step S125> The device-access relay unit 122a determines whether or not a key for access from the guest OS 130 to the HDD 160 is set in the key information stored in the key storage 124, i.e., whether or not the acquired data is encrypted. When yes is determined, the operation goes to step S126. When no is determined, the device-access relay unit 122a transfers the acquired data to the inter-OS communication controller 111a, and the operation goes to step S127.

<Step S126> The device-access relay unit 122a makes the encryption processor 125 decrypt the encrypted data transferred from the device-access relay unit 122a, by using the key which is set in the key storage 124. Then, the device-access relay unit 122a transfers the decrypted data to the inter-OS communication controller 111a.

<Step S127> The inter-OS communication controller 111a receives the data from the device-access relay unit 122a, and transfers the acquired data to the device driver 131.

<Step S128> The device driver 131 receives the data transferred from the inter-OS communication controller 111a, and transfers the acquired data to the application which is the source of the read request.

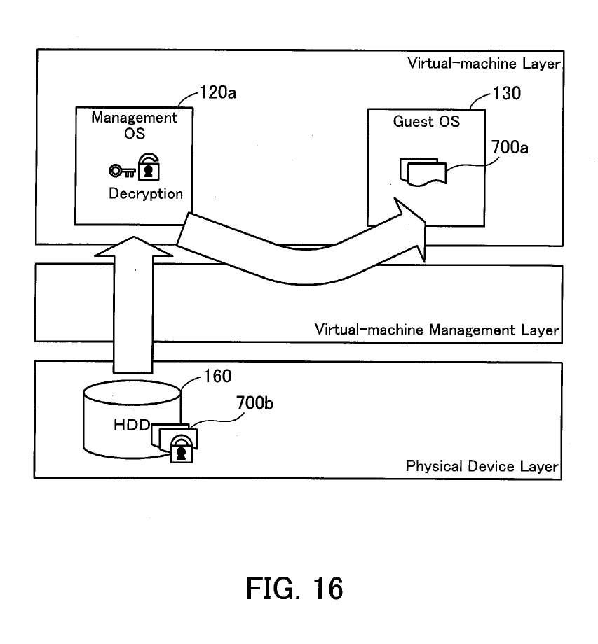

FIG. 16 is a schematic diagram illustrating operations for reading data performed by a guest OS according to the second embodiment. The operations for reading according to the second embodiment are explained below with reference to FIG. 16. (However, explanations on operations similar to some operations in FIG. 9 are not repeated.)

When a read request from an application executed on the guest OS 130 occurs, the read request is transferred through the virtual-machine management layer to the management OS 120a. At this time, the management OS 120a acquires the encrypted data 700b from the HDD 160 on the basis of the received read request, and decrypts the encrypted data 700b to generate the unencrypted data 700a. The unencrypted data 700a is transferred through the virtual-machine management layer to the guest OS 130.

As described above, when a request for access to data occurs on the guest OS 130, access to the HDD 160 through the virtual-machine management layer and the management OS 120a is performed. In addition, the key table 112a is managed in the virtual-machine management layer, and the key which is set for encryption-related processing in correspondence with the guest OS 130 is held by the management OS 120a when the guest OS 130 is started. That is, the key for use in encryption-related processing is managed by the management OS 120a and in the virtual-machine management layer. The management OS 120a performs encryption-related processing of data by using the key held by the management OS 120a. Therefore, the guest OS 130 cannot recognize the functions of the encryption-related processing and the existence of the key. Thus, the key is in no danger of being accessed or leaked out even when the OS is attacked by an unauthorized program such as a computer virus, so that it is possible to improve secrecy of the data stored in the HDD 160.

### 4. Third Embodiment

The third embodiment is explained below with reference to the corresponding drawings. The following explanations on the third embodiment are focused on the differences from the first embodiment, and explanations similar to the first embodiment are not repeated unless necessary.

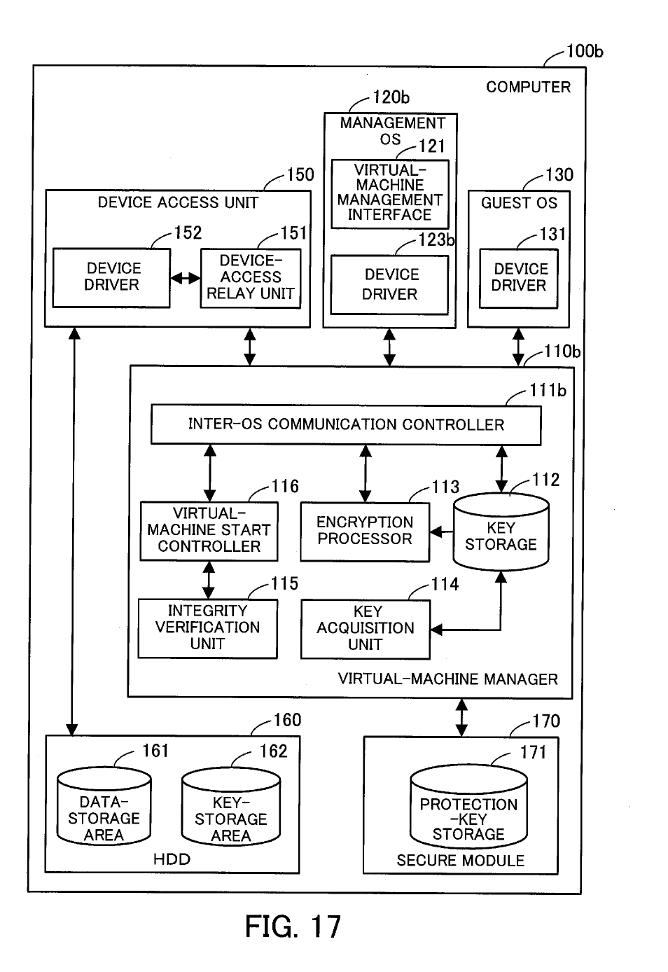

FIG. 17 is a block diagram illustrating the functions of a computer according to the third embodiment. The computer 100b comprises a virtual-machine manager 110b, a management OS 120b, a guest OS 130, and a device access unit 150 as well as the HDD 160 and the secure module 170. The management OS 120b and the guest OS 130 are OSs which run in parallel on the computer 100b. The virtual-machine manager 110b operates with a higher execution privilege than the guest OS 130.

The virtual-machine manager 110b comprises an inter-OS communication controller 111b, a key storage 112, an encryption processor 113, a key acquisition unit 114, an integrity verification unit 115, and a virtual-machine start controller 116. The virtual-machine manager 110b provides an execution environment for each of the management OS 120b, the guest OS 130, and the device access unit 150. When an OS is started on the computer 100b, a virtual machine as the execution environment of the OS is started by the virtual-machine manager 110b, and the OS runs on the virtual machine. The key storage 112, the encryption processor 113, the key acquisition unit 114, the integrity verification unit 115, and the virtual-machine start controller 116 in the computer 100b according to the third embodiment illustrated in FIG. 17 respectively have identical functions and constructions to the corresponding elements in the computer 100 according to the first embodiment illustrated in FIG. 3. The inter-OS communication controller 111b controls data transfer between the management OS 120b, the guest OS 130, and the device access unit 150. The inter-OS communication controller 111b transfers data to be transferred between the OSs, to the encryption processor 113, and makes the encryption processor 113 perform encryption-related processing of the data, when necessary.

The management OS 120b is an OS for management, and is automatically started together with the device access unit 150 when the virtual-machine manager 110b is started. The management OS 120b comprises a virtual-machine management interface 121 and a device driver 123b. The device driver 123b issues a request for access to a device. The device driver 123b has an identical function to the device drivers 131 and 141 illustrated in FIG. 3.

The functions and construction of the guest OS 130 in the computer 100b according to the third embodiment illustrated in FIG. 17 are identical to the guest OS 130 in the computer 100 according to the first embodiment illustrated in FIG. 3. Although only the guest OS 130 is indicated as a guest OS in FIG. 17, more than one guest OS may concurrently run on in the computer 100b.

The device access unit 150 comprises a device-access relay unit 151 and a device driver 152. The device access unit 150 is automatically started together with the management OS 120b when the virtual-machine manager 110b is started. The device-access relay unit 151 is an interface for data transfer between the inter-OS communication controller 111b and the device driver 152. The device driver 152 controls access to a device which the computer 100b has. In the example of FIG. 17, the device driver 152 controls access to the HDD 160. Thus, the device driver 152 relays access to the HDD 160 from each of the key acquisition unit 114, the integrity verification unit 115, the management OS 120b, and the guest OS 130.

The HDD 160 and the secure module 170 in the computer 100b according to the third embodiment illustrated in FIG. 17 respectively have identical functions and constructions to the corresponding elements in the computer 100 according to the first embodiment illustrated in FIG. 3.

As described above, the device driver 152, which corresponds to the device driver 123 arranged in the management OS 120 or 120a in the first or second embodiment illustrated in FIG. 3 or 12, is arranged in the device access unit 150 according to the third embodiment, although the device driver 123 in the first or second embodiment is arranged in the management OS 120 or 120a. In other words, the device access unit 150 containing the device driver 152 is separated from the management OS 120b according to the third embodiment.

Since the flows of operations for writing and reading including encryption-related processing according to the third embodiment are similar to the flows of operations for writing and reading according to the first embodiment, the explanations on the flows of operations for writing and reading as described before with reference to FIGS. 8 to 11 are not repeated. However, operations similar to the operations of the management OS 120 described before with reference to FIGS. 8 to 11 are performed by the device driver 152 in the third embodiment.

In the computer 100b configured as above, when a request for access to data in the HDD 160 occurs on the guest OS 130, access to the HDD 160 through the virtual-machine management layer and the device access unit 150 is performed. In addition, the key table 112a is managed in the virtual-machine management layer, and encryption-related processing of data is performed on the data transfer path between the guest OS 130 and the device access unit 150. Therefore, the guest OS 130 cannot recognize the functions of the encryption-related processing and the existence of the key. Thus, the key is in no danger of being accessed or leaked out even when the OS is attacked by an unauthorized program such as a computer virus, so that it is possible to improve secrecy of the data stored in the HDD 160.

### 5. Fourth Embodiment

The fourth embodiment is explained below with reference to the corresponding drawings. The following explanations on the fourth embodiment are focused on the differences from the first to third embodiments, and explanations similar to the first to third embodiments are not repeated unless necessary.

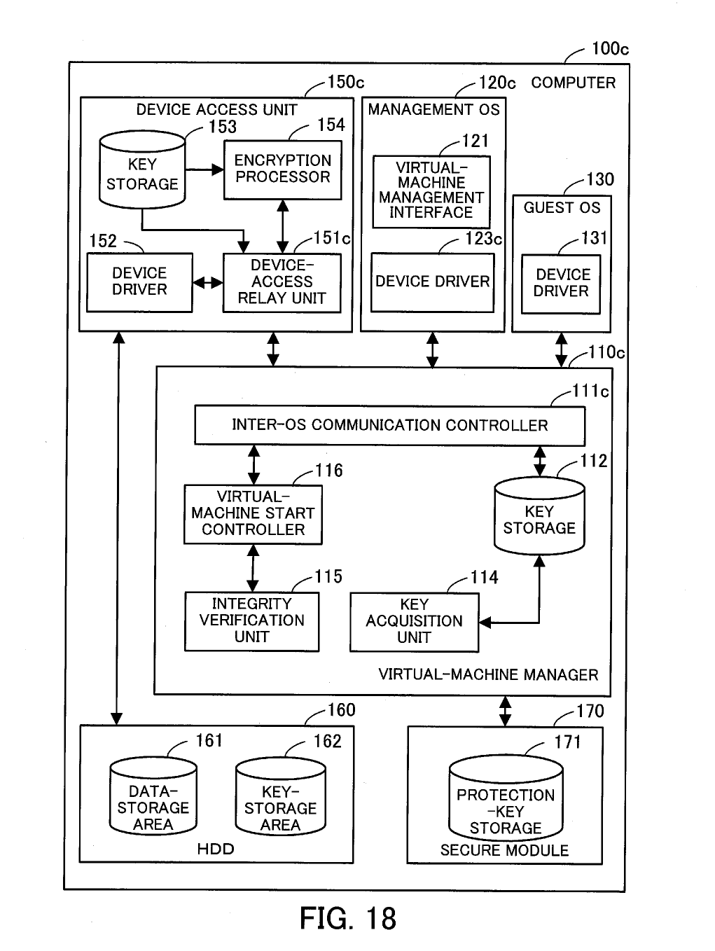

FIG. 18 is a block diagram illustrating the functions of a computer according to the fourth embodiment. The computer 100c comprises a virtual-machine manager 110c, a management OS 120c, a guest OS 130, and a device access unit 150c as well as the HDD 160 and the secure module 170. The management OS 120c and the guest OS 130 are OSs which run in parallel on the computer 100c. The virtual-machine manager 110c operates with a higher execution privilege than the guest OS 130.

The virtual-machine manager 110c comprises an inter-OS communication controller 111c, a key storage 112, a key acquisition unit 114, an integrity verification unit 115, and a virtual-machine start controller 116. The virtual-machine manager 110c provides an execution environment for each of the management OS 120c, the guest OS 130, and the device access unit 150c. When an OS is started on the computer 100c, a virtual machine as the execution environment of the OS is started by the virtual-machine manager 110c, and the OS runs on the virtual machine. The key storage 112, the key acquisition unit 114, the integrity verification unit 115, and the virtual-machine start controller 116 in the computer 100c according to the fourth embodiment illustrated in FIG. 18 respectively have identical functions and constructions to the corresponding elements in the computer 100 according to the first embodiment illustrated in FIG. 3. The inter-OS communication controller 111c controls data transfer between the management OS 120c, the guest OS 130, and the device access unit 150c. When the guest OS 130 is started, the inter-OS communication controller 111c reads out key information corresponding to the guest OS 130 from the key storage 112, and stores the key information in a key storage 153 in the device access unit 150.

The management OS 120c is an OS for management, and is automatically started together with the device access unit 150c when the virtual-machine manager 110c is started. The management OS 120c comprises a virtual-machine management interface 121 and a device driver 123c. The device driver 123c issues a request for access to a device. The device driver 123c has an identical function to the device drivers 131 and 141 illustrated in FIG. 3.

The functions and construction of the guest OS 130 in the computer 100c according to the fourth embodiment illustrated in FIG. 18 are identical to the guest OS 130 in the computer 100 according to the first embodiment illustrated in FIG. 3.

The device access unit 150c comprises a device-access relay unit 151c, a device driver 152, the key storage 153, and an encryption processor 154. The device access unit 150c is automatically started together with the management OS 120c when the virtual-machine manager 110c is started. The device-access relay unit 151c is an interface for data transfer between the inter-OS communication controller 111c and the device driver 152. The functions and construction of the device driver 152 in the computer 100c according to the fourth embodiment illustrated in FIG. 18 are identical to the device driver 152 in the computer 100b according to the third embodiment illustrated in FIG. 17. The key storage 153 stores the key information, which is used for performing encryption-related processing of data. Every time a guest OS is started, the inter-OS communication controller 111c reads out the key information from the key storage 112, and stores the key information in the key storage 153. The encryption processor 154 performs encryption-related processing (i.e., encryption or decryption) of data transferred from the device-access relay unit 151c, by using the key stored in the key storage 153, and transfers to the device-access relay unit 151c the data after the encryption-related processing is performed.

The HDD 160 and the secure module 170 in the computer 100c according to the fourth embodiment illustrated in FIG. 18 respectively have identical functions and constructions to the corresponding elements in the computer 100 according to the first embodiment illustrated in FIG. 3.

As described above, according to the fourth embodiment, the device access unit 150c has the functions for the encryption-related processing as well as the same functions as the device access unit 150 according to the third embodiment.

Since the flows of operations for writing and reading including encryption-related processing according to the fourth embodiment are similar to the flows of operations for writing and reading according to the second embodiment, the explanations on the flows of operations for writing and reading as described before with reference to FIGS. 13 to 16 are not repeated. However, operations similar to the operations of the management OS 120 described before with reference to FIGS. 13 to 16 are performed by the device access unit 150c according to the fourth embodiment.

In the computer 100c configured as above, when a request for access to data in the HDD 160 occurs on the guest OS 130, access to the HDD 160 through the virtual-machine management layer and the device access unit 150c is performed. In addition, the key table 112a is managed in the virtual-machine management layer. When the guest OS 130 is started, the key for encryption-related processing (which is set for the guest OS 130) is stored in the device access unit 150c. That is, the key for use in the encryption-related processing for the guest OS 130 is managed by the device access unit 150c. Therefore, the guest OS 130 cannot recognize the functions of the encryption-related processing and the existence of the key. Thus, the key is in no danger of being accessed or leaked out even when the OS is attacked by an unauthorized program such as a computer virus, so that it is possible to improve secrecy of the data stored in the HDD 160.

### 6. Fifth Embodiment

The fifth embodiment is explained below with reference to the corresponding drawings. The following explanations on the fifth embodiment are focused on the differences from the first embodiment, and explanations similar to the first embodiment are not repeated unless necessary.

### 6.1 Hardware

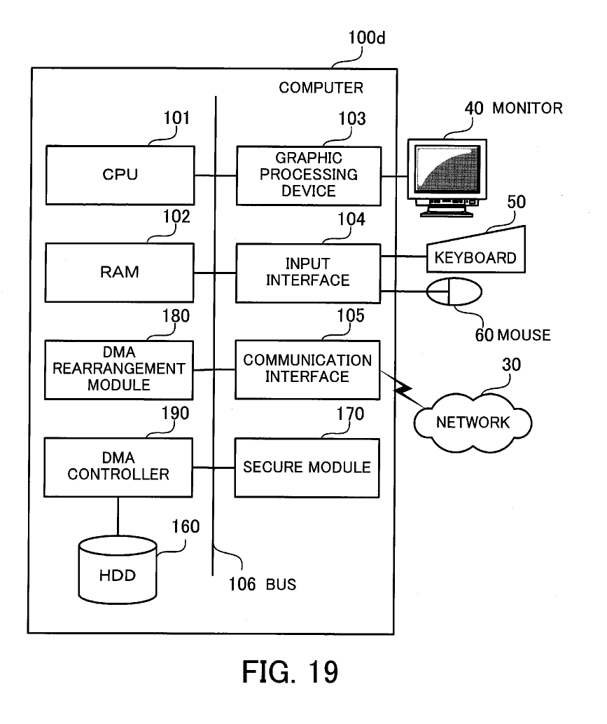

FIG. 19 illustrates the hardware of a computer according to the fifth embodiment. The computer 100d according to the fifth embodiment has functions for DMA (direct memory access). The entire computer 100d is controlled by a CPU (central processing unit) 101, to which a RAM (random access memory) 102, a graphic processing unit 103, an input interface 104, a communication interface 105, an HDD (hard disk drive) 160, a secure module 170, a DMA (direct memory access) rearrangement module 180, and a DMA controller 190 are connected through a bus 106. The CPU 101, the RAM 102, the graphic processing unit 103, the input interface 104, the communication interface 105, the HDD 160, and the secure module 170 in the computer 100d according to the fifth embodiment illustrated in FIG. 19 respectively have identical functions and constructions to the corresponding hardware blocks in the computer 100 according to the first embodiment illustrated in FIG. 2.

The DMA rearrangement module 180 converts a virtual memory address designated by a DMA request into a physical address in the RAM 102, where the DMA request is a request for access to a device by use of the DMA function, and is issued by an OS (operating system). The memory addresses managed by each OS are virtual memory addresses defined by a virtual-machine management program. When a DMA request occurs on an OS, a virtual memory address is required to be converted into a physical address in the RAM 102 in order to identify a memory area used in data input into or output from a device. The DMA rearrangement module 180 realizes the function of the above address conversion by hardware. Since the computer 100d has the DMA rearrangement module 180, address conversion by a virtual-machine management program in accessing from an OS to a device becomes unnecessary, so that the load imposed on the CPU 101 can be reduced.

The DMA controller 190 controls data transfer between the RAM 102 and a device provided in the computer 100d. The DMA controller 190 performs data transfer on the basis of the physical address obtained by the address conversion by the DMA rearrangement module 180. In the construction of FIG. 19, the data transmission between the RAM 102 and the HDD 160 is directly performed by the DMA controller 190 without bothering the CPU 101.

### 6.2 Functions

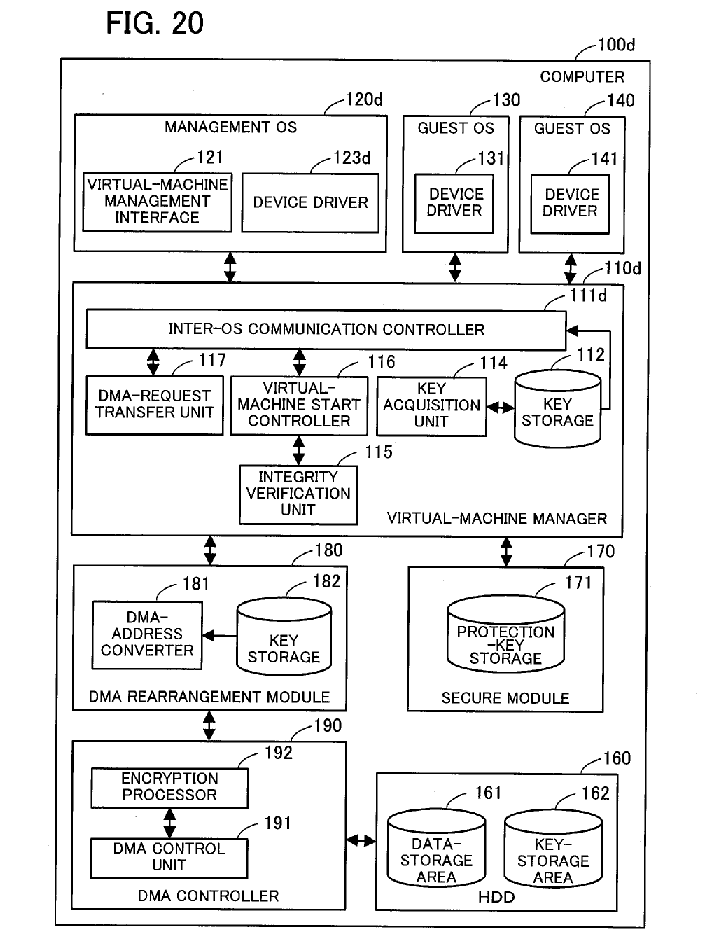

FIG. 20 is a block diagram illustrating the functions of the computer according to the fifth embodiment. The computer 100d comprises a virtual-machine manager 110d, a management OS 120d, guest OSs 130 and 140, a DMA rearrangement module 180, and a DMA controller 190 as well as the HDD 160 and the secure module 170. The management OS 120d and the guest OSs 130 and 140 are OSs which run in parallel on the computer 100d. The virtual-machine manager 110d operates with a higher execution privilege than the guest OSs 130 and 140.

The virtual-machine manager 110d comprises an inter-OS communication controller 111d, a key storage 112, a key acquisition unit 114, an integrity verification unit 115, a virtual-machine start controller 116, and a DMA-request transfer unit 117. The virtual-machine manager 110d provides an execution environment for each of the management OS 120d and the guest OSs 130 and 140. When an OS is started on the computer 100d, a virtual machine as the execution environment of the OS is started by the virtual-machine manager 110d, and the OS runs on the virtual machine. The key storage 112, the key acquisition unit 114, the integrity verification unit 115, and the virtual-machine start controller 116 in the computer 100d according to the fifth embodiment illustrated in FIG. 20 respectively have identical functions and constructions to the corresponding elements in the computer 100 according to the first embodiment illustrated in FIG. 3. The inter-OS communication controller 111d controls data transfer between the management OS 120d and the guest OSs 130 and 140. The inter-OS communication controller 111d reads out, from the key storage 112, key information for use in encryption-related processing of data handled by a currently running guest OS, and stores the key information in a key storage 182 in the DMA rearrangement module 180. The DMA-request transfer unit 117 transfers to a DMA-address converter 181 in the DMA rearrangement module 180 a DMA request issued from the guest OS 130 or 140.

The management OS 120d is an OS for management, and is automatically started when the virtual-machine manager 110d is started. The management OS 120d comprises a virtual-machine management interface 121 and a device driver 123d. The virtual-machine management interface 121 in the computer 100d according to the fifth embodiment illustrated in FIG. 20 has identical functions and construction to the virtual-machine management interface 121 in the computer 100 according to the first embodiment illustrated in FIG. 3. The device driver 123d issues a request for access to a device. The device driver 123d has an identical function to the device drivers 131 and 141 illustrated in FIG. 3.

The guest OSs 130 and 140 in the computer 100d according to the fifth embodiment illustrated in FIG. 20 respectively have identical functions and constructions to the guest OSs 130 and 140 in the computer 100 according to the first embodiment illustrated in FIG. 3.

The DMA rearrangement module 180 comprises the DMA-address converter 181 and the key storage 182. The DMA-address converter 181 converts a virtual memory address for data transfer into a physical address in the RAM 102, where the virtual memory address is designated by a DMA request issued by the guest OS 130 or 140. Then, the DMA-address converter 181 sends to the DMA controller 190 the physical address obtained by the conversion. In addition, the DMA-address converter 181 acquires from the key storage 182 a key for use in encryption-related processing of data, and transfers the acquired key to a DMA control unit 191 in the DMA controller 190, when necessary. The key storage 182 stores one or more keys for use in encryption-related processing of data handled by one or more currently running guest OSs. Every time a guest OS is started, the inter-OS communication controller 111d reads out key information corresponding to the guest OS from the key storage 112, and stores the key information in the key storage 182.

The DMA controller 190 comprises the DMA control unit 191 and an encryption processor 192. The DMA control unit 191 controls data transfer between the RAM 102 and the HDD 160 by DMA. In addition, the DMA control unit 191 transfers to the encryption processor 192 data and a key for use in encryption-related processing, and makes the encryption processor 192 perform encryption-related processing, when necessary. The encryption processor 192 performs encryption-related processing (encryption or decryption) of the data transferred from the DMA control unit 191, by using the key transferred from the DMA control unit 191. Then, the encryption processor 192 transfers to the DMA control unit 191 the data after the encryption-related processing is performed.

### 6.3 Operations

Hereinbelow, details of the operations performed in the computer 100d configured as above are explained.

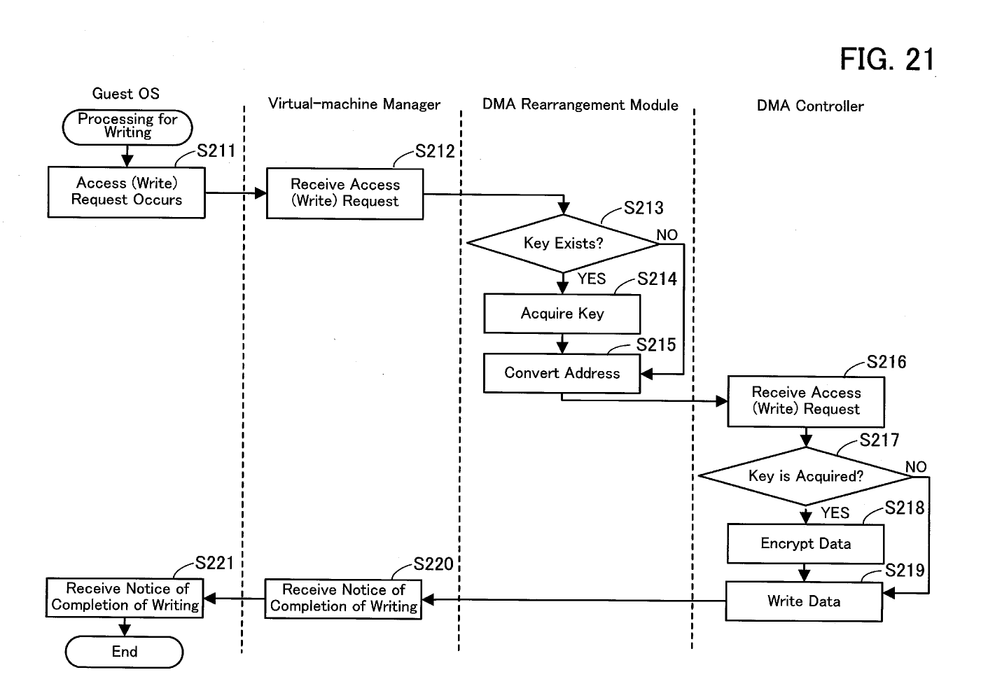

FIG. 21 is a flow diagram illustrating processing for writing by a guest OS according to the fifth embodiment. The processing of FIG. 21 is explained below step by step. In the following explanations, it is assumed that the processing for writing is performed by the guest OS 130. However, processing similar to FIG. 21 is performed when writing is performed by the guest OS 140.

<Step S211> The device driver 131 issues a request (write request) for writing data in the HDD 160, where the write request is accompanied by data to be written.

<Step S212> The inter-OS communication controller 111d receives the write request issued by the device driver 131, and transfers the write request to the DMA-request transfer unit 117. Then, the DMA-request transfer unit 117 transfers the write request to the DMA-address converter 181.

<Step S213> The DMA-address converter 181 receives the write request from the DMA-request transfer unit 117, and then determines whether or not a key for encryption-related processing in access from the guest OS 130 to the HDD 160 is set in the key storage 182. When yes is determined, the operation goes to step S214. When no is determined, the operation goes to step S215.

<Step S214> The DMA-address converter 181 acquires from the key storage 182 the key for encryption-related processing.

<Step S215> The DMA-address converter 181 converts a virtual memory address for data transfer into a physical address, where the virtual memory address is designated by the received write request. Then, the DMA-address converter 181 transmits the write request (in which the address conversion is performed) to the DMA control unit 191. In the case where the key for encryption-related processing is acquired in step S214, the DMA-address converter 181 transmits to the DMA control unit 191 the above key together with the write request.

<Step S216> The DMA control unit 191 receives from the DMA-address converter 181 the write request in which the address conversion is performed. In addition, in the case where the key for encryption-related processing is transmitted from the DMA-address converter 181 in step S215, the DMA control unit 191 receives the transmitted key. Then, the DMA control unit 191 acquires from the RAM 102 the data to be written in the HDD 160, on the basis of the physical address designated in the write request.

<Step S217> The DMA control unit 191 determines whether or not the key is acquired in step S216. When yes is determined, the operation goes to step S218. When no is determined, the operation goes to step S219.

<Step S218> The DMA control unit 191 makes the encryption processor 192 encrypt the data to be written, by using the acquired key.

<Step S219> The DMA control unit 191 stores the encrypted or unencrypted data in the data-storage area 161 in the HDD 160. When the operation of storing in the HDD 160 is completed, the DMA control unit 191 transmits a notice of completion of writing to the DMA-request transfer unit 117.

<Step S220> The DMA-request transfer unit 117 receives the notice of completion of writing, and transfers the received notice to the inter-OS communication controller 111d. Then, the inter-OS communication controller 111d transmits a notice of completion to the device driver 131.

<Step S221> The device driver 131 receives the notice of completion from the inter-OS communication controller 111d.

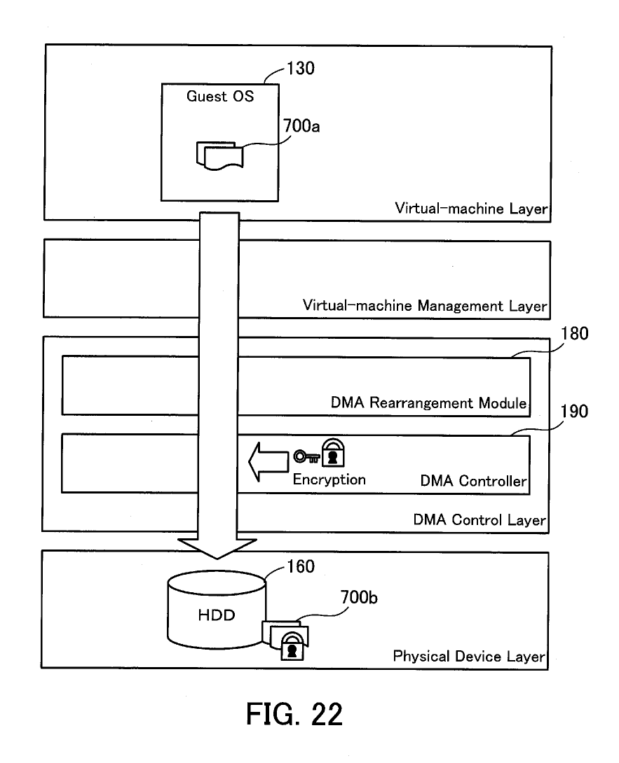

FIG. 22 is a schematic diagram illustrating operations for writing data performed by a guest OS according to the fifth embodiment. The operations for writing according to the fifth embodiment are explained below with reference to FIG. 22. (However, explanations on operations similar to some operations in FIG. 9 are not repeated.)

In FIG. 22, a DMA control layer exists between the virtual-machine management layer and the physical device layer. In the DMA control layer, a DMA request issued by the guest OS 130 is executed. The DMA rearrangement module 180 and the DMA controller 190 belong to the DMA control layer.

When a request (write request) for writing data occurs on the guest OS 130, the write request is transferred to the DMA controller 190 through the virtual-machine management layer and the DMA rearrangement module 180. The key table 112a is managed in the virtual-machine management layer. In the case where a key for encryption-related processing corresponding to the guest OS 130 is set in the key table 112a when the guest OS 130 is started, the above key is read from the key table 112a, and stored in the DMA rearrangement module 180. When a write request occurs, the DMA rearrangement module 180 converts a virtual memory address for data transfer into a physical address in the RAM 102, where the virtual memory address is designated by the DMA request. Then, the DMA rearrangement module 180 transfers the key and the write request (in which the address conversion is performed) to the DMA controller 190. When the DMA controller 190 receives the key and the write request, the DMA controller 190 acquires the unencrypted data 700a from the RAM 102 on the basis of the received write request, where the unencrypted data 700a is data to be written in the HDD 160. Then, the DMA controller 190 encrypts the unencrypted data 700a to generate the encrypted data 700b by using the received key, and stores the encrypted data 700b in the HDD 160.

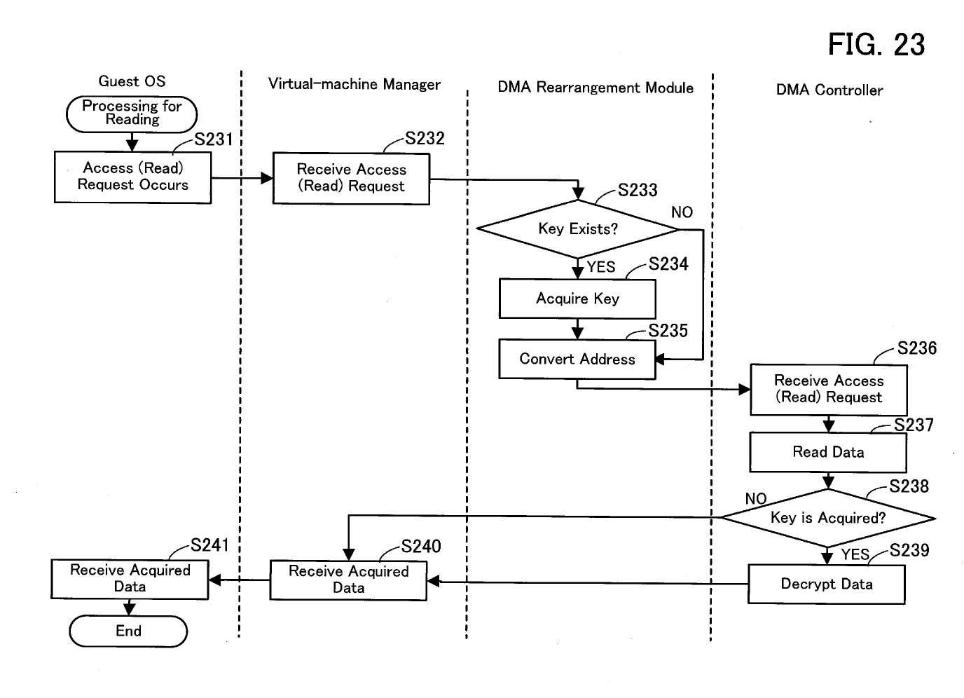

FIG. 23 is a flow diagram illustrating processing for reading by a guest OS according to the fifth embodiment. The processing of FIG. 23 is explained below step by step. In the following explanations, it is assumed that the processing for reading is performed by the guest OS 130. However, processing similar to FIG. 23 is performed when reading is performed by the guest OS 140.

<Step S231> The device driver 131 issues a request (read request) for reading data from the HDD 160. Then, the device driver 131 transmits the read request to the inter-OS communication controller 111d.

<Step S232> The inter-OS communication controller 111d acquires the above read request, and transfers the read request to the DMA-request transfer unit 117. Then, the DMA-request transfer unit 117 transfers the read request to the DMA-address converter 181.

<Step S233> The DMA-address converter 181 receives the read request from the DMA-request transfer unit 117, and determines whether or not a key for access from the guest OS 130 to the HDD 160 is set in the key storage 182. When yes is determined, the operation goes to step S234. When no is determined, the operation goes to step S235.

<Step S234> The DMA-address converter 181 acquires from the key storage 182 a key for encryption-related processing.

<Step S235> The DMA-address converter 181 converts a virtual memory address for data transfer into a physical address, where the virtual memory address is designated by the acquired read request. Then, the DMA-address converter 181 transmits the read request (in which the address conversion is performed) to the DMA control unit 191. In the case where the key for encryption-related processing is acquired in step S234, the DMA-address converter 181 transmits to the DMA control unit 191 the key together with the read request.

<Step S236> The DMA control unit 191 receives the read request (in which the address conversion is performed) from the DMA-address converter 181. At this time, the DMA control unit 191 also receives the key for encryption-related processing in the case where the DMA-address converter 181 transmits the key in step S235.

<Step S237> The DMA control unit 191 reads out the data to be read, from the HDD 160, on the basis of the received read request.

<Step S238> The DMA control unit 191 determines whether or not the key is acquired in step S236. When yes is determined, the operation goes to step S239. When no is determined, the DMA control unit 191 stores in the RAM 102 the data which is read out in step S237, and sends to the DMA-request transfer unit 117 a response indicating completion of the reading, and thereafter the operation goes to step S240.

<Step S239> The DMA control unit 191 makes the encryption processor 192 decrypt the data which is read out in step S237, by using the acquired key. Then, the DMA control unit 191 stores the decrypted data in the RAM 102, and sends to the DMA-request transfer unit 117 a response indicating completion of the reading.

<Step S240> The DMA-request transfer unit 117 transfers to the inter-OS communication controller 111d the data which is read out in step S237. The inter-OS communication controller 111d sends to the device driver 131 the above data transferred from the DMA-request transfer unit 117.

<Step S241> The device driver 131 receives the above data from the inter-OS communication controller 111d.

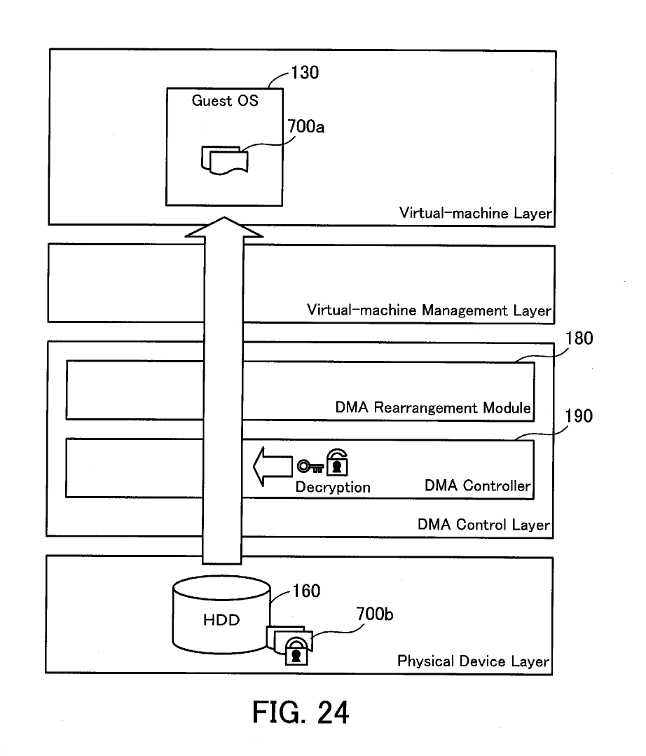

FIG. 24 is a schematic diagram illustrating operations for reading data performed by a guest OS according to the fifth embodiment. The operations for reading according to the fifth embodiment are explained below with reference to FIG. 24. (However, explanations on operations similar to some operations in FIGS. 9 and 22 are not repeated.)

When a request (read request) for reading data occurs on the guest OS 130, the read request is transferred through the virtual-machine management layer and the DMA rearrangement module 180 to the DMA controller 190. The key table 112a is managed in the virtual-machine management layer. In the case where a key for encryption-related processing in correspondence with the guest OS 130 is set in the key table 112a when the guest OS 130 is started, the above key is read from the key table 112a, and stored in the DMA rearrangement module 180. When a read request occurs, the DMA rearrangement module 180 converts a virtual memory address for data transfer into a physical address in the RAM 102, where the virtual memory address is designated by the DMA request. Then, the DMA rearrangement module 180 transfers the key and the read request (in which the address conversion is performed) to the DMA controller 190. When the DMA controller 190 receives the read request and the key, the DMA controller 190 acquires the encrypted data 700b (which is requested to be read) from the HDD 160 on the basis of the received read request. Then, the DMA controller 190 decrypts the encrypted data 700b to generate the unencrypted data 700a by using the received key, and stores the unencrypted data 700a in the RAM 102.

As described above, according to the fifth embodiment, a key for encryption-related processing is passed to the DMA controller 190 (which has the function of encryption-related processing) for making the DMA controller 190 perform the encryption-related processing. In the DMA control layer (which exists under the virtual-machine management layer), data transfer between the RAM 102 and the device is controlled. The key table 112a is managed in the virtual-machine management layer, and the key for encryption-related processing which is set in correspondence with the guest OS 130 is stored in the DMA rearrangement module 180 when the guest OS 130 is started. Therefore, the guest OSs 130 and 140 cannot recognize the functions of the encryption-related processing and the existence of the key. Thus, the key is in no danger of being accessed or leaked out even when the OS is attacked by an unauthorized program such as a computer virus, so that it is possible to improve secrecy of the data stored in the HDD 160. In addition, the load imposed on the CPU 101 can be reduced in the case where the computer is configured so that the DMA rearrangement module 180 performs the processing for address conversion in the DMA request, and the DMA controller 190 performs the encryption-related processing, as in the fifth embodiment.

### 7. Recording Mediums Storing Programs

The processing functions of the computer according to each of the first to fifth embodiments which are explained above can be realized by a program (device-access control program) describing details of operations for realizing the processing functions. When a computer executes the program describing details of operations for realizing the processing functions according to each of the first to fifth embodiments, the processing functions according to the first to fifth embodiments can be realized on the computer.

The program describing the details of the operations can be stored in a computer-readable recording medium which can be read by the computer. The computer-readable recording medium may be a magnetic recording device, an optical disk, an optical magnetic recording medium, a semiconductor memory, or the like. The magnetic recording device may be a hard disk drive (HDD), a flexible disk (FD), a magnetic tape (MT), or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the program into the market, for example, it is possible to sell a portable recording medium such as a DVD or a CD-ROM in which the program is recorded. Alternatively, it is possible to store the program in a storage device belonging to a server computer, and transfer the program to another computer through a network.

The computer which executes the program according to each of the first to fifth embodiments stores the program in a storage devices belonging to the computer, where the program is originally recorded in, for example, a portable recording medium, or is initially transferred from the server computer. The computer reads out the program from the storage device, and performs processing in accordance with the program. Alternatively, the computer may directly read the program from the portable recording medium for performing processing in accordance with the program. Further alternatively, each computer can sequentially execute processing in accordance with each portion of a program every time the portion of the program is transferred from the server computer.

### 8. Advantages of Embodiments

According to the first to fifth embodiments, a key corresponding to each operating system is managed by using a memory area which is different from a memory area used by an operating system, and encryption-related processing is performed on the path for access from the operating system to a device. Therefore, the operating system can write or read data into or from the device even when the key is not managed by the operating system. In addition, it is impossible to take the key from the operating system, i.e., it is possible to prevent leakage of the key, even when the operating system is attacked by an unauthorized program such as a computer virus. Thus, the secrecy of the data inputted into the device can be ensured.

### 9. Additional Matters

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that various changes, substitutions and alterations could be made hereto without departing from the spirit and scope of the invention.

Specifically, each element constituting the device-access control program, the device-access control process, and the information processing apparatus according to the first to fifth embodiments may be replaced with another element having a similar function, and any further element or any further step may be added to the device-access control program, the device-access control process, or the information processing apparatus according to the first to fifth embodiments. Further, it is possible to arbitrarily combine two or more of the features of the first to fifth embodiments explained before.

What is claimed is:

1. A computer-readable medium storing a device-access control program which makes a computer perform processing for controlling access to one or more devices, where the computer has memory areas, a plurality of operating systems run in parallel in the computer, and said device-access control program realizes in the computer:
a key storage which includes memory areas different from memory areas used by said plurality of operating systems, to store one or more keys for use by one or more of the plurality of operating systems in encryption-related processing of data which is to be inputted into said one or more devices or is outputted from the one or more devices, in correspondence with the one or more of the plurality of operating systems; and
an encryption processor which encrypts first data outputted from a first one of the plurality of operating systems by using a first one of said one or more keys corresponding to the first one of the plurality of operating systems in response to a first request by the first one of the plurality of operating systems for access to the one or more devices before transferring the first data to said one or more devices, and decrypts second data being encrypted and outputted from the one or more devices, by using a second one of the one or more keys corresponding to a second one of the plurality of operating systems in response to a second request by the second one of the plurality of operating systems for access to the one or more devices before transferring the second data to the second one of the plurality of operating systems.

2. The computer-readable medium according to claim 1, wherein said key storage stores said one or more keys for each of said one or more devices, and said encryption processor encrypts or decrypts data by using a key corresponding to one of the one or more devices which is to be accessed.

3. The computer-readable medium according to claim 1, wherein said computer comprises a DMA controller having a function of encryption-related processing and being connected to at least one of said one or more devices, and said encryption processor acquires from said key storage a key corresponding to one of the plurality of operating systems which issues said first request or said second request for access to said one or more devices, sets the acquired key in said DMA controller, and encrypts said first data or decrypts said second data, in response to the first request or the second request by using the DMA controller.

4. The computer-readable medium according to claim 1, wherein a predetermined one of said one or more devices is a storage device storing, in encrypted form, a key table as a list of said one or more keys for use in encryption-related processing, said computer comprises a secure module which is tamper-resistant, and stores a protection key for use in encryption of said key table, said device-access control program further realizes a key acquisition unit in the computer, and when the computer is started, the key acquisition unit acquires said key table in encrypted form from said predetermined one of the one or more devices, decrypts the key table by using said protection key stored in said secure module, and stores the decrypted key table in said key storage.

5. A device-access control process for controlling access to one or more devices in a computer which has memory areas and in which a plurality of operating systems run in parallel, comprising:
storing, in memory areas different from memory areas used by said plurality of operating systems, one or more keys for use by one or more of the plurality of operating systems in encryption-related processing of data which is to be inputted into said one or more devices or is outputted from the one or more devices, in correspondence with the one or more of the plurality of operating systems;
encrypting first data outputted from a first one of the plurality of operating systems by using a first one of said one or more keys corresponding to the first one of the plurality of operating systems in response to a first request by the first one of the plurality of operating systems for access to the one or more devices before transferring the first data to said one or more devices; and
decrypting second data being encrypted and outputted from the one or more devices, by using a second one of the one or more keys corresponding to a second one of the plurality of operating systems in response to a second request by the second one of the plurality of operating systems for access to the one or more devices before transferring the second data to the second one of the plurality of operating systems.

6. The device-access control process according to claim 5, wherein said one or more keys are stored in said one or more of the memory areas for each of said one or more devices, and each of encryption of said first data and decryption of said second data is performed by using a key corresponding to one of the one or more devices which is to be accessed.

7. The device-access control process according to claim 5, wherein said computer comprises a DMA controller having a function of encryption-related processing and is connected to at least one of said one or more devices; in said encrypting, in response to said first request, said first one of the one or more keys corresponding to said first one of the plurality of operating systems which issues the first request is acquired from said one or more of the memory areas, and set in the DMA controller, and said first data is encrypted by using the DMA controller; and in said decrypting, in response to said second request, said second one of the one or more keys corresponding to said second one of the plurality of operating systems which issues the second request is acquired from the one or more of the memory areas, and set in the DMA controller, and said second data is decrypted by using the DMA controller.

8. The device-access control process according to claim 5, wherein a predetermined one of said one or more devices is a storage device storing, in encrypted form, a key table as a list of said one or more keys for use in encryption-related processing, said computer comprises a secure module which is tamper-resistant, and stores a protection key for use in encryption of said key table, and when the computer is started, the key acquisition unit acquires said key table in encrypted form from said predetermined one of the one or more devices, decrypts the key table by using said protection key stored in said secure module, and stores the decrypted key table in said one or more of the memory areas.

9. An information processing apparatus for controlling access to one or more devices in a computer which has memory areas and in which a plurality of operating systems run in parallel, comprising:
a key storage which has memory areas different from memory areas used by said plurality of operating systems, to store one or more keys for use by one or more of the plurality of operating systems in encryption-related processing of data which is to be inputted into said one or more devices or is outputted from the one or more devices, in correspondence with the one or more of the plurality of operating systems; and
an encryption processor which encrypts first data outputted from a first one of the plurality of operating systems by using a first one of said one or more keys corresponding to the first one of the plurality of operating systems in response to a first request by the first one of the plurality of operating systems for access to the one or more devices before transferring the first data to said one or more devices, and decrypts second data being encrypted and outputted from the one or more devices, by using a second one of the one or more keys corresponding to a second one of the plurality of operating systems in response to a second request by the second one of the plurality of operating systems for access to the one or more devices before transferring the second data to the second one of the plurality of operating systems.

10. The information processing apparatus according to claim 9, wherein said key storage stores said one or more keys for each of said one or more devices, and each of encryption of said first data and decryption of said second data is performed by using a key corresponding to one of the one or more devices which is to be accessed.

11. The information processing apparatus according to claim 9, further comprising a DMA controller having a function of encryption-related processing and being connected to at least one of said one or more devices, wherein said encryption processor acquires from said key storage a key corresponding to one of the plurality of operating systems which issues said first request or said second request for access to said one or more devices, sets the acquired key in said DMA controller, and encrypts said first data or decrypts said second data by using the DMA controller, in response to the first request or the second request.

12. The information processing apparatus according to claim 9, wherein a predetermined one of said one or more devices stores, in encrypted form, a key table as a list of said one or more keys for use in encryption-related processing, said computer comprises a secure module which is tamper-resistant, and stores a protection key for use in encryption of said key table, said device-access control program further realizes a key acquisition unit in the computer, and when the computer is started, the key acquisition unit acquires said key table in encrypted form from said predetermined one of the one or more devices, decrypts the key table by using said protection key stored in said secure module, and stores the decrypted key table in said key storage.
